(19) United States
(12) Patent Application Publication
(10) Pub. No.: US 2025/0267520 A1
(43) Pub. Date: Aug. 21, 2025

(54) DYNAMIC BANDWIDTH EXPANSION

(71) Applicant: QUALCOMM Incorporated, San Diego, CA (US)

(72) Inventors: George CHERIAN, San Diego, CA (US); Gaurang NAIK, San Diego, CA (US); Simon Jan BRAND, Pleasanton, CA (US); Alfred ASTERJADHI, San Diego, CA (US); Abhishek Pramod PATIL, San Diego, CA (US); Sai Yiu Duncan HO, San Diego, CA (US); Sanket Sanjay KALAMKAR, San Diego, CA (US); Giovanni CHISCI, San Diego, CA (US); Sherief HELWA, San Diego, CA (US)

(21) Appl. No.: 19/053,656

(22) Filed: Feb. 14, 2025

Related U.S. Application Data
(60) Provisional application No. 63/554,721, filed on Feb. 16, 2024.

(51) Int. Cl. H04W 28/20; H04L 5/00; H04W 72/0453

(52) U.S. Cl. CPC H04W 28/20; H04L 5/0048; H04L 5/0098; H04W 72/0453

(57) ABSTRACT

This disclosure provides methods, components, devices and systems for dynamic bandwidth expansion. Some aspects more specifically relate to one or more configuration- or signaling-based mechanisms according to which various wireless communication devices, such as access points (APs) or stations (STAs), may communicate via an expanded bandwidth. For example, a total available bandwidth may be divided into different wireless channels, with each wireless channel being associated with a respective basic service set (BSS) of a respective AP. A wireless communication device may establish a communication link associated with a first wireless channel (the first wireless channel being associated with a BSS bandwidth of the wireless communication device) and, in accordance with one or more criteria, may communicate via a bandwidth that includes the first wireless channel associated with the BSS bandwidth and one or more other wireless channels outside of the BSS bandwidth.

### CROSS REFERENCE

The present Application for Patent claims the benefit of U.S. Provisional Patent Application No. 63/554,721 by Cherian, et al., entitled “DYNAMIC BANDWIDTH EXPANSION,” filed Feb. 16, 2024, assigned to the assignee hereof, and expressly incorporated by reference herein.

### TECHNICAL FIELD

This disclosure relates generally to wireless communication and, more specifically, to dynamic bandwidth expansion.

### DESCRIPTION OF THE RELATED TECHNOLOGY

Wireless communication networks are widely deployed to provide various types of communication content such as voice, video, packet data, messaging, broadcast, and so on. Some wireless communication networks may be capable of supporting communication with multiple users by sharing the available system resources (such as time, frequency, or power). Further, a wireless communication network may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM), among other examples. Wireless communication devices may communicate in accordance with any one or more of such wireless communication technologies, and may include wireless stations (STAs), wireless access points (APs), user equipment (UEs), network entities, or other wireless nodes.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a wireless communication device. The wireless communication device may include a processing system that includes processor circuitry and memory circuitry that stores code. The processing system may be configured to cause the wireless communication device to establish a wireless communication link associated with a first wireless channel, where the first wireless channel is associated with a BSS bandwidth of the wireless communication device, communicate information indicative of at least one time period, where the at least one time period is associated with communication via an expanded bandwidth that includes the first wireless channel associated with the BSS bandwidth and one or more wireless channels outside of the BSS bandwidth, and communicate, during a time period of the at least one time period, via a bandwidth that includes the first wireless channel associated with the BSS bandwidth and at least one of the one or more wireless channels outside of the BSS bandwidth.

Another innovative aspect of the subject matter described in this disclosure can be implemented in a method for wireless communication by or at a wireless communication device. The method may include establishing a wireless communication link associated with a first wireless channel, where the first wireless channel is associated with a BSS bandwidth of the wireless communication device, communicating information indicative of at least one time period, where the at least one time period is associated with communication via an expanded bandwidth that includes the first wireless channel associated with the BSS bandwidth and one or more wireless channels outside of the BSS bandwidth, and communicating, during a time period of the at least one time period, via a bandwidth that includes the first wireless channel associated with the BSS bandwidth and at least one of the one or more wireless channels outside of the BSS bandwidth.

Another innovative aspect of the subject matter described in this disclosure can be implemented in a wireless communication device. The wireless communication device may include means for establishing a wireless communication link associated with a first wireless channel, where the first wireless channel is associated with a BSS bandwidth of the wireless communication device, means for communicating information indicative of at least one time period, where the at least one time period is associated with communication via an expanded bandwidth that includes the first wireless channel associated with the BSS bandwidth and one or more wireless channels outside of the BSS bandwidth, and means for communicating, during a time period of the at least one time period, via a bandwidth that includes the first wireless channel associated with the BSS bandwidth and at least one of the one or more wireless channels outside of the BSS bandwidth.

Another innovative aspect of the subject matter described in this disclosure can be implemented in a non-transitory computer-readable medium storing code for wireless communication. The code may include instructions executable by one or more processors to establish a wireless communication link associated with a first wireless channel, where the first wireless channel is associated with a BSS bandwidth of a wireless communication device, communicate information indicative of at least one time period, where the at least one time period is associated with communication via an expanded bandwidth that includes the first wireless channel associated with the BSS bandwidth and one or more wireless channels outside of the BSS bandwidth, and communicate, during a time period of the at least one time period, via a bandwidth that includes the first wireless channel associated with the BSS bandwidth and at least one of the one or more wireless channels outside of the BSS bandwidth.

In some examples of the method, wireless communication devices, and non-transitory computer-readable medium described herein, communicating the information indicative of the at least one time period may include operations, features, means, or instructions for communicating information indicative of a restricted target wake time schedule associated with a set of multiple service periods, where the at least one time period includes the set of multiple service periods, and where the set of multiple service periods may be protected for the communication via the expanded bandwidth.

In some examples of the method, wireless communication devices, and non-transitory computer-readable medium described herein, communicating the information indicative of the at least one time period may include operations, features, means, or instructions for communicating a first control frame that includes an indication of the bandwidth that includes the first wireless channel associated with the BSS bandwidth and the at least one of the one or more wireless channels outside of the BSS bandwidth, where communication of the first control frame may be associated with a start of the time period, and communicating a second control frame that includes an indication of the first wireless channel associated with the BSS bandwidth, where communication of the second control frame may be associated with an end of the time period.

In some examples of the method, wireless communication devices, and non-transitory computer-readable medium described herein, the at least one time period consists of a single dynamic service period.

Another innovative aspect of the subject matter described in this disclosure can be implemented in a wireless communication device. The wireless communication device may include a processing system that includes processor circuitry and memory circuitry that stores code. The processing system may be configured to cause the wireless communication device to establish a wireless communication link associated with a first wireless channel, where the first wireless channel is associated with a BSS bandwidth of the wireless communication device, sense a first primary subchannel of the first wireless channel associated with the BSS bandwidth using a first energy detection threshold value, sense one or more primary subchannels of one or more wireless channels outside of the BSS bandwidth using a second energy detection threshold value, where the second energy detection threshold value is different than the first energy detection threshold value, and communicate via a bandwidth that includes the first wireless channel associated with the BSS bandwidth and at least one of the one or more wireless channels outside of the BSS bandwidth in association with sensing the first primary subchannel associated with the BSS bandwidth using the first energy detection threshold value and sensing the one or more primary subchannels outside of the BSS bandwidth using the second energy detection threshold value.

Another innovative aspect of the subject matter described in this disclosure can be implemented in a method for wireless communication by or at a wireless communication device. The method may include establishing a wireless communication link associated with a first wireless channel, where the first wireless channel is associated with a BSS bandwidth of the wireless communication device, sensing a first primary subchannel of the first wireless channel associated with the BSS bandwidth using a first energy detection threshold value, sensing one or more primary subchannels of one or more wireless channels outside of the BSS bandwidth using a second energy detection threshold value, where the second energy detection threshold value is different than the first energy detection threshold value, and communicating via a bandwidth that includes the first wireless channel associated with the BSS bandwidth and at least one of the one or more wireless channels outside of the BSS bandwidth in association with sensing the first primary subchannel associated with the BSS bandwidth using the first energy detection threshold value and sensing the one or more primary subchannels outside of the BSS bandwidth using the second energy detection threshold value.

Another innovative aspect of the subject matter described in this disclosure can be implemented in a wireless communication device. The wireless communication device may include means for establishing a wireless communication link associated with a first wireless channel, where the first wireless channel is associated with a BSS bandwidth of the wireless communication device, means for sensing a first primary subchannel of the first wireless channel associated with the BSS bandwidth using a first energy detection threshold value, means for sensing one or more primary subchannels of one or more wireless channels outside of the BSS bandwidth using a second energy detection threshold value, where the second energy detection threshold value is different than the first energy detection threshold value, and means for communicating via a bandwidth that includes the first wireless channel associated with the BSS bandwidth and at least one of the one or more wireless channels outside of the BSS bandwidth in association with sensing the first primary subchannel associated with the BSS bandwidth using the first energy detection threshold value and sensing the one or more primary subchannels outside of the BSS bandwidth using the second energy detection threshold value.

Another innovative aspect of the subject matter described in this disclosure can be implemented in a non-transitory computer-readable medium storing code for wireless communication. The code may include instructions executable by one or more processors to establish a wireless communication link associated with a first wireless channel, where the first wireless channel is associated with a BSS bandwidth of the wireless communication device, sense a first primary subchannel of the first wireless channel associated with the BSS bandwidth using a first energy detection threshold value, sense one or more primary subchannels of one or more wireless channels outside of the BSS bandwidth using a second energy detection threshold value, where the second energy detection threshold value is different than the first energy detection threshold value, and communicate via a bandwidth that includes the first wireless channel associated with the BSS bandwidth and at least one of the one or more wireless channels outside of the BSS bandwidth in association with sensing the first primary subchannel associated with the BSS bandwidth using the first energy detection threshold value and sensing the one or more primary subchannels outside of the BSS bandwidth using the second energy detection threshold value.

Some examples of the method, wireless communication devices, and non-transitory computer-readable medium described herein may further include operations, features, means, or instructions for decrementing a network allocation vector counter associated with the first wireless channel in association with sensing the first primary subchannel associated with the BSS bandwidth using the first energy detection threshold value and sensing the one or more primary subchannels outside of the BSS bandwidth using the second energy detection threshold value, where communicating via the bandwidth that includes the first wireless channel associated with the BSS bandwidth and the at least one of the one or more wireless channels outside of the BSS bandwidth may be in association with sensing the first primary subchannel associated with the BSS bandwidth and at least one of the one or more primary subchannels outside of the BSS bandwidth as idle when the network allocation vector counter may be a zero value.

In some examples of the method, wireless communication devices, and non-transitory computer-readable medium described herein, sensing the first primary subchannel associated with the BSS bandwidth and the one or more primary subchannels outside of the BSS bandwidth may include operations, features, means, or instructions for sensing each subchannel using a respective energy detector of the wireless communication device.

Some examples of the method, wireless communication devices, and non-transitory computer-readable medium described herein may further include operations, features, means, or instructions for maintaining, in association with sensing the first primary subchannel associated with the BSS bandwidth and the one or more primary subchannels outside of the BSS bandwidth, a respective random backoff counter associated with each wireless channel of a set of wireless channels including the first wireless channel associated with the BSS bandwidth and the one or more wireless channels outside of the BSS bandwidth.

In some examples of the method, wireless communication devices, and non-transitory computer-readable medium described herein, random backoff counters associated with the first wireless channel associated with the BSS bandwidth and the at least one of the one or more wireless channels outside of the BSS bandwidth reach zero at least once prior to communicating via the bandwidth that includes the first wireless channel associated with the BSS bandwidth and the at least one of the one or more wireless channels outside of the BSS bandwidth.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of another example wireless communication network.

FIG. 3 shows an example wireless communication network that supports dynamic bandwidth expansion.

FIGS. 4-7 show example communication timelines that support dynamic bandwidth expansion.

FIG. 8 shows an example process flow that supports dynamic bandwidth expansion.

FIG. 9 shows a block diagram of an example wireless communication device that supports dynamic bandwidth expansion.

FIGS. 10-12 show flowcharts illustrating example processes performable by or at a wireless communication device that support dynamic bandwidth expansion.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

Various aspects relate generally to dynamic bandwidth expansion, such as dynamic expansion to a bandwidth greater than a basic service set (BSS) bandwidth. Some aspects more specifically relate to one or more configuration- or signaling-based mechanisms according to which various wireless communication devices, such as access points (APs) or stations (STAs), may communicate via an expanded bandwidth. For example, in some deployments, a total available bandwidth may be divided into different (contiguous or noncontiguous) wireless channels, with each wireless channel being associated with a respective BSS of a respective AP. In such deployments, a wireless communication device (such as an AP or a STA) may establish a communication link associated with a first wireless channel (the first wireless channel being associated with a BSS bandwidth of the wireless communication device) and, in accordance with some example implementations, the wireless communication device may communicate via a bandwidth that includes the first wireless channel associated with the BSS bandwidth and one or more other wireless channels outside of the BSS bandwidth.

A wireless communication device may communicate via such an expanded bandwidth in association with satisfying one or more criteria associated with expanded bandwidth communication. In some examples, the criteria may be associated with an operation of multiple auxiliary radios, with each auxiliary radio operating on a different wireless channel of the total available bandwidth. In such examples, a wireless communication device may monitor and maintain synchronization with each wireless channel of the total available bandwidth (even with wireless channels outside of a BSS bandwidth) and may selectively communicate via an expanded bandwidth if one or more out-of-BSS wireless channels are available (such as idle). In some other examples, the criteria may be associated with an operation of a single auxiliary radio (or, generally, a limited quantity of auxiliary radios) with multiple packet detectors, each packet detector associated with a different wireless channel of the total available bandwidth. In such examples, a wireless communication device may maintain synchronization with each wireless channel of the total available bandwidth in association with switching the single auxiliary radio to different wireless channels (in accordance with detecting a presence of Wi-Fi packets).

Additionally, or alternatively, the criteria may be associated with a service period associated with expanded bandwidth communication. For example, a wireless communication device may perform expanded bandwidth communication within a service period and may otherwise refrain from performing expanded bandwidth communication. In some implementations, a service period may be associated with a restricted target wake time (r-TWT) schedule. In such implementations, wireless communication devices may negotiate or coordinate on the r-TWT schedule via management frame signaling. Additionally, or alternatively, a service period may be a dynamic service period (such as any dynamically indicated period of time). In such implementations, a wireless communication device may schedule, establish, create, or initiate a dynamic service period via relatively more dynamic signaling, such as control frame signaling. In some aspects, such signaling (such as control frame signaling) may indicate, flag, demarcate, or otherwise define the start and end times of a dynamic service period.

Additionally, or alternatively, the criteria may be associated with an energy detection scheme across the wireless channels of the total available bandwidth. For example, a wireless communication device may selectively perform expanded bandwidth communication in accordance with one or more energy detection measurements across the wireless channels of the total available bandwidth. In some implementations, the wireless communication device may use a relatively lower energy detection threshold value on wireless channels outside of a BSS bandwidth (as compared to another threshold value that a wireless communication device may use for in-BSS primary subchannel energy detection). For example, the energy detection threshold value may be set equal or similar to an energy level threshold value associated with packet detection. In some aspects, the wireless communication device may use a first energy detection threshold value to sense an in-BSS primary subchannel and may use a second energy detection threshold value (such as a relatively lower energy detection threshold value) to sense out-of-BSS primary subchannels. The energy detection scheme may involve energy detection based contention, such as contention using energy detection, on out-of-BSS channels (such that, in some examples, a respective random backoff (RBO) counter is maintained for each out-of-BSS wireless channel). Additionally, or alternatively, the energy detection scheme may involve a Point Coordination Function Inter-frame Spacing (PIFS) energy detection check on out-of-BSS channels (such that an RBO process may be largely, partially, or entirely skipped for at least some out-of-BSS wireless channels, with an energy measurement instead performed during, for example, a single or limited (small) quantity of slots).

Particular aspects of the subject matter described in this disclosure can be implemented to realize one or more of the following potential advantages. In some examples, by supporting one or more configuration- or signaling-based mechanisms to enable or facilitate expanded bandwidth communication, the described techniques can be used to achieve greater spectrum usage (and, likewise, greater spectral efficiency) as wireless communication devices may have more opportunities to make use of idle spectrum. Further, the described techniques can be used to achieve relatively higher throughput and lower latency by way of communicating data via larger bandwidths (which, for example, may be able to carry more bits per second) while also maintaining or preserving channelization benefits associated with a separation of the total available bandwidth into different BSS bandwidths. For example, in accordance with some of the example implementations of the present disclosure, wireless communication devices may opportunistically transmit via an expanded bandwidth when channelization gains are relatively lower and may refrain from transmitting via an expanded bandwidth when channelization gains are relatively higher (which may be the case when a quantity of channel accesses is relatively large, such that expanded bandwidth communication may be outcompeted by in-BSS communication on the different wireless channels). Further, in accordance with some of the example implementations of the present disclosure, wireless communication devices of varying capabilities may support expanded bandwidth communication while also preserving backward compatibility with relatively lower capability wireless communication devices. Moreover, various example implementations of the present disclosure support mechanisms that address various complicating factors associated with out-of-BSS communication, including inter-BSS hidden node issues, which may result in greater communication reliability.

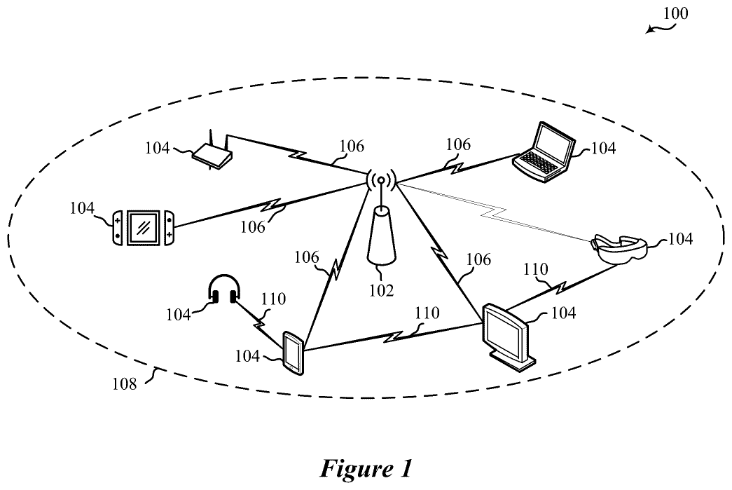

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHZ-52.6 GHZ), FR3 (7.125 GHZ-24.25 GHZ), FR4a or FR4-1 (52.6 GHz-71 GHZ), FR4 (52.6 GHz-114.25 GHZ), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHZ, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as an AP 102 or a STA 104) may puncture the subchannels on which there is interference and in essence spread the data of the PPDU to cover the remaining portion of the bandwidth of the channel. For example, if a transmitting device determines (such as detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

In some examples, the AP 102 or the STAs 104 of the wireless communication network 100 may implement Extremely High Throughput (EHT) or other features compliant with current and future generations of the IEEE 802.11 family of wireless communication protocol standards (such as the IEEE 802.11be and 802.11bn standard amendments) to provide additional capabilities over other previous systems (such as High Efficiency (HE) systems or other legacy systems). For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MHZ, 40 MHz, 80 MHz, 160 MHz, 240 MHz, and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHZ bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the universal signal (U-SIG) field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of RBOs so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHZ, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHZ band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHZ, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (cMLMR) mode of operation, in which the MLD may be capable of dynamically switching radio resources (such as antennas or RF frontends) between multiple communication links (such as switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (such as monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHZ band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

An AP 102 and a STA 104 may associate with each other and communicate using a bandwidth associated with a BSS of the AP 102 and, in some implementations, may dynamically increase the bandwidth used for communication between the AP 102 and the STA 104 to exceed the bandwidth associated with the BSS of the AP 102. In other words, the AP 102 and the STA 104 may support dynamic bandwidth expansion. The AP 102 and the STA 104 may communicate using a bandwidth that exceeds the BSS bandwidth in accordance with satisfying one or more criteria or in accordance with indicating (such as scheduling) a time period within which an expanded bandwidth is to be used for communication, or both. Such a time period may be any (dynamically) indicated period of time, such as a service period.

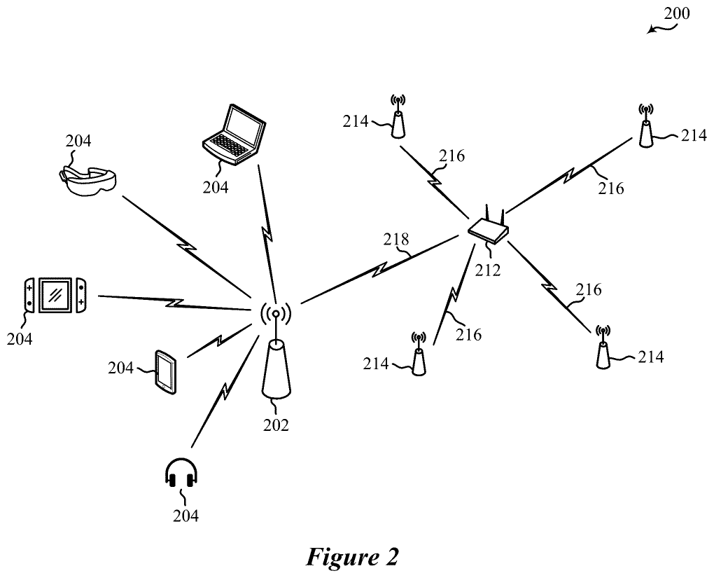

FIG. 2 shows a pictorial diagram of another example wireless communication network 200. According to some aspects, the wireless communication network 200 can be an example of a mesh network, an IoT network, or a sensor network in accordance with one or more of the IEEE 802.11 family of wireless communication protocol standards (including the 802.11ah amendment). The wireless communication network 200 may include multiple wireless communication devices 214, which in some implementations may include APs 202, STAs 204, or both. The wireless communication devices 214 may represent various devices such as display devices (such as TVs, computer monitors, navigation systems, among others), music or other audio or stereo devices, remote control devices (“remotes”), printers, kitchen or other household appliances, among other examples.

In some examples, the wireless communication devices 214 sense, measure, collect or otherwise obtain and process data and transmit such raw or processed data to an intermediate device 212 for subsequent processing or distribution. Additionally, or alternatively, the intermediate device 212 may transmit control information, digital content (such as audio or video data), configuration information or other instructions to the wireless communication devices 214. The intermediate device 212 and the wireless communication devices 214 can communicate with one another via wireless communication links 216. In some examples, the wireless communication links 216 include Bluetooth links or other PAN or short-range communication links.

In some examples, the intermediate device 212 also may be configured for wireless communication with other networks such as with a WLAN or a wireless (such as cellular) wide area network (WWAN), which may, in turn, provide access to external networks including the Internet. For example, the intermediate device 212 may associate and communicate, over a Wi-Fi link 218, with an AP 102 of a wireless communication network 200, which also may serve various STAs 104. In some examples, the intermediate device 212 is an example of a network gateway, for example, an IoT gateway. In such a manner, the intermediate device 212 may serve as an edge network bridge providing a Wi-Fi core backhaul for the IoT network including the wireless communication devices 214. In some examples, the intermediate device 212 can analyze, preprocess and aggregate data received from the wireless communication devices 214 locally at the edge before transmitting it to other devices or external networks via the Wi-Fi link 218. The intermediate device 212 also can provide additional security for the IoT network and the data it transports.

The various wireless communication devices illustrated by and described with reference to FIGS. 1 and 2 may support one or more signaling- or configuration-based mechanisms according to which such wireless communication devices may dynamically switch between different reuse (such as frequency or channel reuse) schemes to allow, enable, facilitate, or support a dynamically expanded PPDU bandwidth (such as a bandwidth that is greater than a BSS bandwidth). In other words, such signaling- or configuration-based mechanisms may allow, enable, facilitate, or support dynamic channelization within a given area (such as within a given geographic area). For example, if four APs 102 are present within a geographic area and if a total amount of available bandwidth is 320 MHz, the four APs 102 may dynamically switch between splitting the 320 MHz into different wireless channels (such as one (dedicated) 80 MHz wireless channel for each of the four APs 102) and consolidating two or more different wireless channels (such as two or more 80 MHz wireless channels) into one expanded wireless channel (such as an expanded bandwidth), which an AP 102 (or any other wireless communication device) may use to achieve relatively higher throughout and relatively lower latency (as compared to when the 320 MHz is split into four dedicated 80 MHz wireless channels).

Further, although some example implementations of dynamically adjusting a channelization of a 320 MHz bandwidth are illustrated and described herein, the described techniques should be understood as being applicable to dynamically adjusting a channelization of any bandwidth, such as a 40 MHz bandwidth, an 80 MHZ bandwidth, a 160 MHz bandwidth, a 240 MHz bandwidth, a 320 MHz bandwidth, a 400 MHz bandwidth, a 480 MHz bandwidth, or a 640 MHz bandwidth. Further, although illustrated and described in some example scenarios as being attributable to an AP 102 or a STA 104, the described techniques may be implemented by any wireless communication device, including a STA 104, an AP 102, an AP 202, a STA 204, a wireless communication device 214, or any combination thereof.

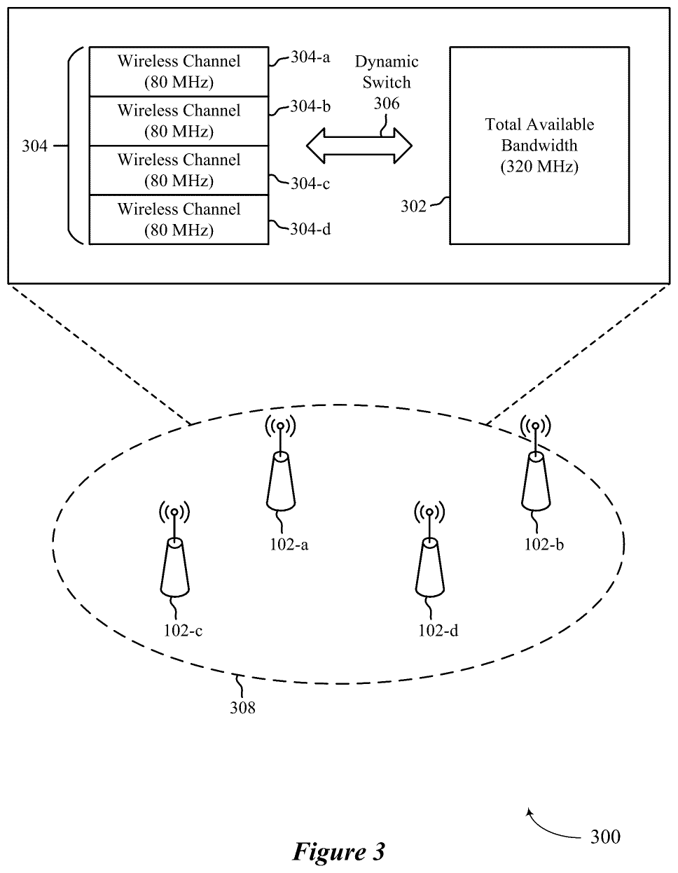

FIG. 3 shows an example wireless communication network 300 that supports dynamic bandwidth expansion. The wireless communication network 300 may implement or be implemented to realize one or more aspects of the wireless communication network 100 and wireless communication network 200. For example, the wireless communication network 300 includes a set of APs 102, which may be examples of APs 102 as illustrated by or described with reference to FIGS. 1 and 2. The set of APs 102 may include an AP 102-a, an AP 102-b, an AP 102-c, and an AP 102-d. Further, although the example wireless communication network 300 shows four APs 102, the described techniques should be understood as being applicable to any quantity of APs 102, such as two APs 102, three APs 102, four APs 102, five APs 102, six APs 102, and so on.

In some implementations, the APs 102 may be associated with a deployment within a geographic area 308 and one or both of the deployment or the geographic area 308 may be associated with a total available bandwidth 302. In some examples, and as illustrated by FIG. 3, such a total available bandwidth 302 may be 320 MHz. In some other examples, the total available bandwidth 302 may be 40 MHz, 80 MHz, 160 MHZ, 240 MHz, 400 MHZ, 480 MHz, or 640 MHz. The total available bandwidth 302 may be contiguous or noncontiguous. In accordance with the deployment associated with the APs 102, the APs 102 or a network controller may split the total available bandwidth 302 into different channels depending on (such as in accordance with or associated with) an anticipated (such as expected, assumed, predicted, or indicated) utilization or density of channel accesses.

In some examples, if the deployment is anticipated to have a relatively larger quantity of channel accesses, the APs 102 or the network controller may configure (such as setup or establish) the wireless communication network 300 with relatively more channelization (which may reduce a likelihood of collision loss). In such examples, the total available bandwidth 302 may be split into different bandwidths (such as different wireless channels), with each AP 102 operating with a different BSS bandwidth. For example, the APs 102 or the network controller may configure the wireless communication network 300 such that the AP 102-a uses a wireless channel 304-a, the AP 102-b uses a wireless channel 304-b, the AP 102-c uses a wireless channel 304-c, and the AP 102-d uses a wireless channel 304-d. In an example in which the total available bandwidth 302 is 320 MHz, each wireless channel 304 may span or include 80 MHz (such as a contiguous 80 MHz portion of the available 320 MHZ). In other words, the 320 MHz bandwidth may be split into four 80 MHz bandwidths, with each AP 102 operating with a respective 80 MHz BSS bandwidth. Further, although illustrated and described in examples in which each AP 102 is configured or allocated with a same amount of bandwidth (such that all of the wireless channels 304 span or include a same amount of bandwidth, such as each spanning or including 80 MHZ), APs 102 may be configured or allocated with different amounts of bandwidths without exceeding the scope of the present disclosure (such as if one AP 102 expects relatively more traffic or a relatively heavier load as compared to another AP 102).

In some other examples, if the deployment associated with the APs 102 is anticipated to have a relatively smaller quantity of channel accesses, the APs 102 or the network controller may configure the wireless communication network 300 with relatively less channelization (as the APs 102 may prefer to utilize the full bandwidth in such scenarios of relatively low channel access). For example, the APs 102 or the network controller may configure the wireless communication network 300 such that each AP 102 may be configured or allocated with the total available bandwidth 302 (or a relatively large portion thereof). In other words, the total available bandwidth 302 may be used in a single reuse mode, with each AP 102 operating with a BSS bandwidth equal to the total available bandwidth 302 (such as a 320 MHz BSS bandwidth). In such examples, the use of BSS bandwidths equal to the total available bandwidth 302 may help, for example, 320 MHz (or, generally, relatively wider bandwidth capable) client devices to take more (such as full) advantage of the total available bandwidth 302, which may increase throughput and reduce latency.

In many scenarios, however, a traffic load within a geographic area 308 may vary significantly. For example, an enterprise network anticipating a relatively large quantity of channel accesses may experience relatively low quantities of channel accesses at times. By way of further example, APs 102 within a meeting room may be configured or allocated wireless channels 304 anticipating a relatively large quantity of channel access, but may experience relatively low quantities of channel accesses in between meetings. Thus, in accordance with some example implementations of the present disclosure, APs 102 (and other wireless communication devices, such as STAs 104) may support dynamic channelization.

In the example of FIG. 3, which shows four APs 102, such a dynamic channelization may be associated with a switch between reuse 1 (such that one wireless channel 304 may be allocated from the total available bandwidth 302) and reuse 4 (such that four wireless channels 304 may be allocated from the total available bandwidth 302), among other examples. In accordance with such a dynamic channelization, an AP 102 (or a STA 104 associated with the AP 102, or both) may perform a dynamic switch 306 between using the total available bandwidth 302 and using a single wireless channel 304 (such as the single wireless channel 304 initially or originally configured or allocated for the AP 102 in accordance with the anticipated traffic load). In other words, the APs 102 (and one or more associated STAs 104) may support an expanded PPDU bandwidth (such as a PPDU bandwidth greater than a BSS bandwidth) dynamically.

In accordance with supporting the dynamic switch 306, APs 102 (among other wireless communication devices, such as STAs 104) may support one or more mechanisms associated with client device synchronization (which may include, in some implementations, a constraint against a client device switching its primary subchannel when the dynamic switch 306 is performed), allowing, enabling, facilitating, or otherwise supporting both uplink and downlink communication, and maintaining backward compatibility with legacy client devices that are not capable of communicating via an expanded bandwidth. Further, APs 102 (among other wireless communication devices, such as STAs 104) may support one or more mechanisms associated with identifying or remedying potential inter-channel hidden node issues, as some APs 102 (or any other wireless communication device associated with a given BSS) may be blind to (such as unable to detect, monitor, or parse) transmissions outside its BSS bandwidth.

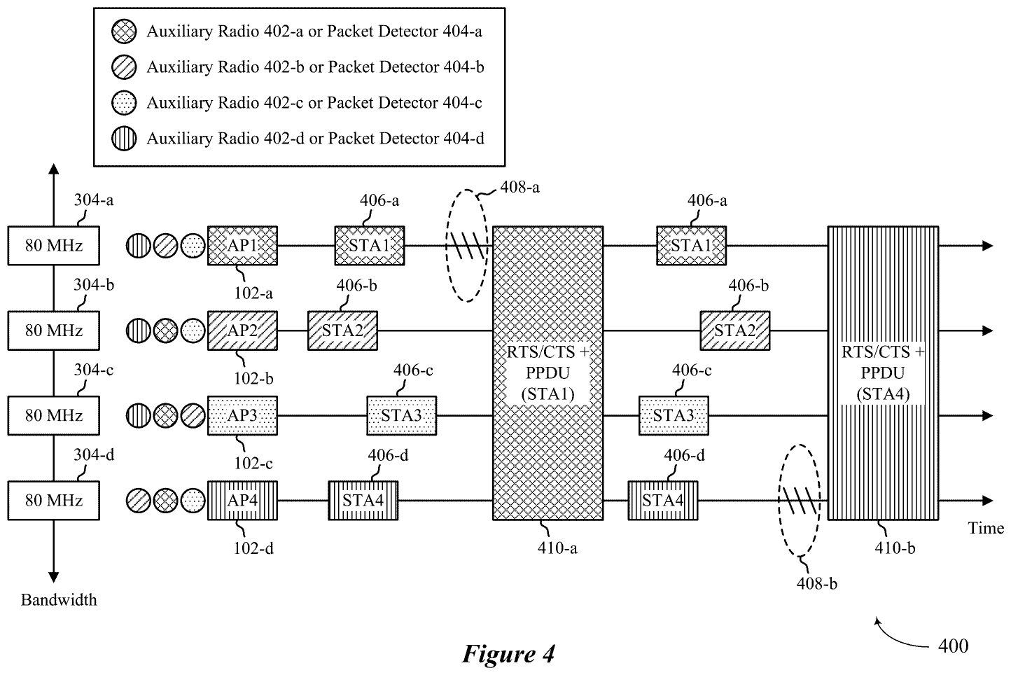

FIG. 4 shows an example communication timeline 400 that supports dynamic bandwidth expansion. The communication timeline 400 may implement or be implemented to realize one or more aspects of the wireless communication network 100, the wireless communication network 200, and the wireless communication network 300. For example, the communication timeline 400 illustrates communication between various APs 102 and various associated STAs 104, which may be examples of corresponding devices as illustrated by and described with reference to FIGS. 1-3. In some implementations, the various APs 102 and various associated STAs 104 may support one or more configuration- or signaling-based mechanisms associated with dynamic (BSS) bandwidth expansion.

In some examples, each AP 102 (and any associated wireless communication devices, including one or more STAs 104) may establish (such as negotiate, configure, allocate, transmit or receive information indicative of, or otherwise use) a respective wireless communication link associated with a respective wireless channel 304 (such as a respective BSS bandwidth of that AP 102). For example, the AP 102-a may establish the wireless channel 304-a as a BSS bandwidth of the AP 102-a, the AP 102-b may establish the wireless channel 304-b as a BSS bandwidth of the AP 102-b, the AP 102-c may establish the wireless channel 304-c as a BSS bandwidth of the AP 102-c, and the AP 102-d may establish the wireless channel 304-d as a BSS bandwidth of the AP 102-d. Likewise, a STA 104 associated with the AP 102-a may establish a wireless communication link using the wireless channel 304-a, a STA 104 associated with the AP 102-b may establish a wireless communication link using the wireless channel 304-b, a STA 104 associated with the AP 102-c may establish a wireless communication link using the wireless channel 304-c, and a STA 104 associated with the AP 102-d may establish a wireless communication link using the wireless channel 304-d.

The wireless channel 304-a, the wireless channel 304-b, the wireless channel 304-c, and the wireless channel 304-d may be examples of the corresponding wireless channels 304 as illustrated by and described with reference to FIG. 3. For example, the wireless channel 304-a, the wireless channel 304-b, the wireless channel 304-c, and the wireless channel 304-d may be different portions of bandwidth from a total available bandwidth 302. The wireless channel 304-a, the wireless channel 304-b, the wireless channel 304-c, and the wireless channel 304-d may be contiguous or noncontiguous.

The APs 102 may communicate with one or more associated STAs 104 via a BSS bandwidth (such as via any one or more subchannels within a BSS bandwidth). Such communication may include one or both of transmission or reception of one or more packets, such as Wi-Fi packets or PPDUs. For example, the AP 102-a may communicate one or more packets 406-a with one or more STAs 104 associated with the AP 102-a, the AP 102-b may communicate one or more packets 406-b with one or more STAs 104 associated with the AP 102-b, the AP 102-c may communicate one or more packets 406-c with one or more STAs 104 associated with the AP 102-c, and the AP 102-d may communicate one or more packets 406-d with one or more STAs 104 associated with the AP 102-d.

In some implementations, at least one wireless communication device may support (such as use, operate, or configure) one or multiple auxiliary radios and may use the one or multiple auxiliary radios to dynamically communicate via an expanded bandwidth (such as a bandwidth greater than a BSS bandwidth). For example, the AP 102-a may support one or multiple auxiliary radios 402-a, the AP 102-b may support one or multiple auxiliary radios 402-b, the AP 102-c may support one or multiple auxiliary radios 402-c, and the AP 102-d may support one or multiple auxiliary radios 402-d.

An auxiliary radio may be an example of a radio (such as a component of an RF front end of a wireless communication device) that is associated with relatively lower complexity or relatively less capability as compared to one or more other radios of a wireless communication device, such as a main radio. For example, an auxiliary radio may be capable of reception and may be incapable of transmission. An auxiliary radio may contrast with a main radio of a wireless communication device, as a wireless communication device may use a main radio for both transmission and reception (at least sequentially). Further, an auxiliary radio may only receive one or more specific PPDU types (such as only non-HT PPDUs), may only receive PPDUs sent using a single spatial stream (or, generally, a limited (relatively small, such as 1 or 2) quantity of spatial streams), may only support one or more specific PHY rates (such as only one of 6 megabits per second (Mbps), 12 Mbps, or 24 Mbps), may be capable of monitoring only a 20 MHz bandwidth, or any combination thereof. Thus, an auxiliary radio may be referred to or understood as a low power receiver or radio, a low power wake up receiver or radio, a low complexity receiver or radio, a secondary receiver or radio, a non-primary or non-main receiver or radio, a receive-only radio, or the like. A main radio may be referred to or understood as a primary radio, a relatively more capable or complex radio, a radio associated with (such as coupled with) relatively more circuitry, processing blocks, or processing capability as compared to an auxiliary radio, a transmit and receive radio, or the like. In some aspects, an auxiliary radio may be used to monitor a different wireless channel than a main radio of a wireless communication device. Additionally, or alternatively, an auxiliary radio may be used to monitor a same wireless channel as a main radio of a wireless communication device (such as, for example, to improve reception gain).

A wireless communication device may use one or multiple auxiliary radios to monitor, simultaneously (such as in parallel) or sequentially, one or more wireless channels 304 outside of the wireless channel 304 associated with the BSS bandwidth of the wireless communication device. For example, the AP 102-a (associated with a BSS bandwidth corresponding to the wireless channel 304-a) may monitor one or more of the wireless channel 304-b, the wireless channel 304-c, or the wireless channel 304-d, simultaneously or sequentially, using the one or multiple auxiliary radios 402-a. By way of further example, the AP 102-b (associated with a BSS bandwidth corresponding to the wireless channel 304-b) may monitor one or more of the wireless channel 304-a, the wireless channel 304-c, or the wireless channel 304-d, simultaneously or sequentially, using the one or multiple auxiliary radios 402-b. By way of further example, the AP 102-c (associated with a BSS bandwidth corresponding to the wireless channel 304-c) may monitor one or more of the wireless channel 304-a, the wireless channel 304-b, or the wireless channel 304-d, simultaneously or sequentially, using the one or multiple auxiliary radios 402-c. By way of further example, the AP 102-d (associated with a BSS bandwidth corresponding to the wireless channel 304-d) may monitor one or more of the wireless channel 304-a, the wireless channel 304-b, or the wireless channel 304-c, simultaneously or sequentially, using the one or multiple auxiliary radios 402-d. A wireless communication device supporting one or more auxiliary radios may use the auxiliary radios to monitor wireless channels 304 outside of a BSS bandwidth and may use a main radio to monitor a wireless channel 304 associated with (such as within or corresponding to) the BSS bandwidth.

In some implementations, a wireless communication device may support multiple auxiliary radios and may monitor each wireless channel 304 using a respective auxiliary radio of the multiple auxiliary radios. For example, the AP 102-a may support a first auxiliary radio 402-a on the wireless channel 304-b, a second auxiliary radio 402-a on the wireless channel 304-c, and a third auxiliary radio 402-a on the wireless channel 304-d. Such support for multiple auxiliary radios, with one on each channel, may be associated with a non-primary channel access (NPCA) Type-0 configuration. In such implementations, an expanded bandwidth transmission may occur at any time (such that an expanded bandwidth transmission may not be restricted to specific time periods, time epochs, or service periods). For example, a wireless communication device that might try or attempt to use a wireless channel 304 outside of a BSS bandwidth of the wireless communication device may host an auxiliary radio on (at least) the wireless channel 304 and, in accordance with hosting the auxiliary radio on the wireless channel 304, may keep or maintain synchronization with the wireless channel 304. Such synchronization with the wireless channel 304 may be associated with a maintenance of a NAV counter, such as a NAV status or timer, associated with the wireless channel 304. Thus, the wireless communication device may obtain information indicative of when the wireless channel 304 is busy or occupied and when the wireless channel 304 might be free or idle (and available for use as part of an expanded bandwidth transmission).

Additionally, or alternatively, a wireless communication device may support (such as use, operate, or configure) one or multiple packet detectors. For example, the AP 102-a may support one or multiple packet detectors 404-a, the AP 102-b may support one or multiple packet detectors 404-b, the AP 102-c may support one or multiple packet detectors 404-c, and the AP 102-d may support one or multiple packet detectors 404-d. A wireless communication device may support one or multiple packet detectors in addition to supporting one or multiple auxiliary radios.

In some aspects, a wireless communication device may support one or multiple packet detectors with a quantity of auxiliary radios less than a quantity of the wireless channels 304 within the total available bandwidth 302. In such aspects, the wireless communication device may move one or more auxiliary radios between different wireless channels 304 as packets are detected, as the auxiliary radio(s) of the wireless communication device may not be able to simultaneously span the total available bandwidth 302. For example, the wireless communication device may support multiple packet detectors with a single auxiliary radio. In implementations in which the wireless communication device supports multiple packet detectors, the wireless communication device may support one packet detector on each wireless channel 304 (which may be associated with an NPCA Type-1 configuration).

In other words, a wireless communication device that might try or attempt to use a wireless channel 304 outside of a BSS bandwidth of the wireless communication device may host (such as support, use, deploy, or configure) a packet detector on the wireless channel 304. For example, the AP 102-a may support a first packet detector 404-a on the wireless channel 304-b, a second packet detector 404-a on the wireless channel 304-c, and a third packet detector 404-a on the wireless channel 304-d. In accordance with supporting multiple packet detectors, an expanded bandwidth transmission may occur at any time (such that an expanded bandwidth transmission may not be restricted to specific time periods, time epochs, or service periods).

In implementations in which a wireless communication device supports multiple packet detectors, with one packet detector on each wireless channel 304, the wireless communication device may switch an auxiliary radio of the wireless communication device to a wireless channel on which the wireless communication device detects a packet (such as a Wi-Fi packet). For example, when a Wi-Fi packet is detected on a wireless channel 304, the wireless communication device may switch an auxiliary radio to the wireless channel 304 on which the Wi-Fi packet is detected 304 (if the auxiliary radio is not already on that wireless channel 304) to decode at least a portion of the Wi-Fi packet. A wireless communication device may use a packet detector to detect a received packet as a Wi-Fi packet in accordance with a correlation scheme or component. For example, the packet detector may scan or search for one or more types or variants of sequences (such as a short training field (STF) sequence) that are specific to Wi-Fi packets. If a received packet includes such a sequence that is specific to Wi-Fi packets, a correlation between one or more hypothesis sequences and the received sequence may spike at the packet detector. Such a spike in correlation (such as an increase in correlation or a relatively high correlation, such as above a threshold correlation level) may indicate, to the packet detector and to the wireless communication device (via the packet detector) that a received packet is likely a Wi-Fi packet.

For example, if a first packet detector 404-a of the AP 102-a detects a packet 406-b on the wireless channel 304-b, the AP 102-a may switch an auxiliary radio 402-a of the AP 102-a to the wireless channel 304-b to decode (such as parse) at least a portion of the packet 406-b. Such a portion of the packet 406-b may include one or more fields via which the AP 102-a may identify, determine, ascertain, obtain, or otherwise parse information indicative of a duration of the packet 406-b, which may enable the AP 102-a to maintain synchronization (in terms of a NAV counter, status, or timer) associated with the wireless channel 304-b. For example, the AP 102-a may set a first NAV counter associated with the wireless channel 304-b in accordance with the duration of the packet 406-b (such that the first NAV counter is set to a value that corresponds to, such as is equal to, the duration of the packet 406-b). For further example, if a second packet detector 404-a of the AP 102-a detects a packet 406-c on the wireless channel 304-c, the AP 102-a may switch the auxiliary radio 402-a of the AP 102-a to the wireless channel 304-c to decode (such as parse) at least a portion of the packet 406-c to obtain information indicative of a duration of the packet 406-c. In such examples, the AP 102-a may set a second NAV counter associated with the wireless channel 304-c in accordance with the duration of the packet 406-c (such that the second NAV counter is set to a value that corresponds to, such as is equal to, the duration of the packet 406-c). In some implementations, an RBO counter associated with an expanded BSS transmission may consider an inter-BSS/channel NAV status. For example, a wireless communication device may stop an RBO counter at the wireless communication device if the NAV is set on one or more wireless channels 304 that the wireless communication device monitors.

In some scenarios, a wireless communication device may detect packets within a threshold duration of each other (such as at approximately the same time). In such scenarios, the wireless communication device may be unable to use a single auxiliary radio to decode both packets. In some examples, the wireless communication device may select to decode one of the multiple packets using the single auxiliary radio. Such a selected one of the multiple packets may include a first (such as initially) detected packet, a last (such as latest or most recently) detected packet, a packet associated with another AP 102 (or any other wireless communication device) relatively closest to the wireless communication device (which a wireless communication device may identify, determine, or ascertain in accordance with one or more signal strength measurements and/or an explicitly signaled indication, such as via coordinate location information), a random packet of the multiple packets, or a packet selected in accordance with some other criteria.

A wireless communication device may obtain information indicative of a duration via one or more of various fields of a Wi-Fi packet, which may be referred to or understood as a PPDU. In some aspects, such one or more of various fields may depend on a version of the Wi-Fi packet or PPDU. For example, the wireless communication device may obtain the information indicative of the duration from a “Duration/ID” field of a MAC header or an “HE-SIG-A” field of a PHY header if the Wi-Fi packet (such as a PPDU) is an HE PPDU or a “U-SIG” field of the PHY header if the Wi-Fi packet (such as the PPDU) is an extremely high throughput (EHT) or a ultra-high reliability (UHR) PPDU.

In some implementations, a wireless communication device may support a relatively lower energy detection threshold value that the wireless communication device uses to sense out-of-BSS wireless channels 304 of the total available bandwidth 302. For example, as part of an RBO process for an expanded BSS transmission, the wireless communication device may use an energy detection threshold value for out-of-BSS channels that is, for instance, lowered to match a packet detection threshold. Such a packet detection threshold may be −82 decibel milliwatts (dBm). In such examples, the wireless communication device may sense (at least a primary subchannel of) each out-of-BSS wireless channel 304 and may measure an out-of-BSS wireless channel 304 as busy if the wireless communication device senses the out-of-BSS wireless channel 304 with an energy level value that fails to satisfy (such as is greater than) the relatively lower energy detection threshold value. In such implementations, the wireless communication device may perform an expanded bandwidth transmission at any time (such that expanded bandwidth transmissions may not be restricted to specific time periods, time epochs, or service periods). In accordance with using a relatively lower energy detection threshold value to sense out-of-BSS wireless channels 304, a wireless communication device may refrain from performing puncturing on any “busy” channels in accordance with monitoring a primary subchannel (and refraining from monitoring other subchannels or channels).

As an example, a wireless communication device may sense an in-BSS primary subchannel using a first energy detection threshold value and may sense one or more out-of-BSS primary subchannels using a second energy detection threshold value. The second energy detection threshold value (such as −82 dBm) may be relatively lower than the first energy detection threshold value (such as −72 dBm or −62 dBm). Alternatively, in some examples, the first energy detection threshold value and the second energy detection threshold value may be the same (such that both may be one of −82 dBm, −72 dBm, or −62 dBm). Generally, an energy detection threshold of an in-BSS primary channel may not be the same as the energy detection threshold of out-of-BSS primary channels. For example, an in-BSS primary channel could use a regular, baseline, or default energy detection threshold (such as −62 dBm in some geographic areas and −72 dBm in some other geographic areas), and the out-of-BSS primary channels may use a same relatively lower threshold of −82 dBm (which is lower than the typical, regular, baseline, or default energy detection ED threshold value).

In some implementations, a wireless communication device may run (such as perform) an RBO process using a baseline or default (such as typical or regular) energy detection threshold value (such as −72 dBm or −62 dBm) within a BSS bandwidth. In such implementations, the wireless communication device may be restricted to communicating via the BSS bandwidth (such as not via an expanded bandwidth) once the wireless communication device obtains channel access in accordance with running the RBO process within the BSS bandwidth. In such implementations, the wireless communication device may sense a primary subchannel of the BSS bandwidth using the baseline or default energy detection threshold value (such as −72 dBm or −62 dBm). In some examples, the wireless communication device also may sense one or more non-primary subchannels of the BSS bandwidth using the baseline or default energy detection threshold value (such as −72 dBm or −62 dBm).

In some implementations, a wireless communication device may support multiple energy detection contenders (such as multiple energy detectors), with one energy detection contender on each channel (which may be associated with an NPCA Type-2+ configuration), and may use the relatively lower energy detection threshold value for out-of-BSS wireless channels 304. Such implementations may be understood as involving a lowered energy detection threshold value and energy detection based RBO for the out-of-BSS wireless channels 304. For example, in such implementations, the wireless communication device may perform energy detection (using the relatively lower threshold value of −82 dBm) contention on primary subchannels associated with out-of-BSS wireless channels 304. In other words, the wireless communication device may maintain an RBO counter on each out-of-BSS primary subchannel (across the wireless channels 304 of the total available bandwidth 302) and may count down (such as decrement) the RBO counter in each slot when the energy detection yields or otherwise indicates an “idle” result.

As an alternative to, or in addition to, maintaining an RBO counter on each out-of-BSS primary subchannel, the wireless communication device may perform a one-shot PIFS energy detection check (using the relatively lower threshold value of −82 dBm) on the primary subchannels of the out-of-BSS wireless channels 304. Such a PIFS energy detection check may be associated with an energy measurement across a single slot or for a duration of PIFS (such as 25 microseconds) before the RBO counts down to zero on the out-of-BSS primary subchannel and with an otherwise skipped RBO process. In implementations in which the wireless communication device maintains a respective RBO counter for each primary subchannel across the wireless channels 304 (with each wireless channel 304 including a different primary subchannel), the wireless communication device may perform energy detection based (using a first, such as baseline or default, energy detection threshold value of −72 dBm or −62 dBm) and packet detection based contention on a primary subchannel of an in-BSS wireless channel 304 and may perform energy detection based (using a second, such as relatively lower, energy detection threshold value of −82 dBm) contention on the primary subchannels of the out-of-BSS wireless channels 304.

In some aspects, the wireless communication device may transmit via an expanded bandwidth including an out-of-BSS wireless channel 304 if an energy detection contender on that out-of-BSS wireless channel 304 has counted down (using an RBO counter) to a zero value (“0”) at least once. Otherwise, if the energy detection contender on that out-of-BSS wireless channel 304 has not counted down to the zero value at least once, a wireless communication device may exclude that out-of-BSS wireless channel 304 from an expanded bandwidth transmission. For example, a wireless communication device may transmit via the total available bandwidth 302 (such as the 320 MHz bandwidth) only if the energy detection contender on every primary subchannel (across the wireless channels 304) has counted down to the zero value at least once. In accordance with such implementations associated with tracking which energy detection contenders have counted down to a zero value at least once, a wireless communication device may support greater fairness with other wireless communication devices on the other primary subchannels (such as the primary subchannels of the out-of-BSS wireless channels 304 via which the wireless communication device performs the expanded bandwidth transmission).

In accordance with monitoring various wireless channels 304 outside of a BSS bandwidth using one or multiple auxiliary radios, one or multiple packet detectors, or a relatively lower energy detection threshold value for out-of-BSS wireless channels 304, a wireless communication device may maintain an understanding of which one or more wireless channels 304 are available (such as idle) and which one or more wireless channels 304 are occupied (such as busy). The wireless communication device may communicate via a bandwidth that includes a wireless channel 304 associated with a BSS bandwidth and one or more wireless channels 304 outside of the BSS bandwidth in accordance with maintaining such an understanding. For example, if the wireless communication device measures, identifies, parses, or otherwise obtains information indicating that all wireless channels 304 within the total available bandwidth 302 are idle, the wireless communication device may communicate (with another wireless communication device, such as with an associated AP 102 or STA 104) via the total available bandwidth 302.

By way of further example, if the wireless communication device measures, identifies, parses, or otherwise obtains information indicating that a wireless channel 304 of the total available bandwidth 302 is busy (such as in accordance with a nonzero NAV counter, a nonzero RBO counter, or an energy detection check failing to satisfy a threshold energy detection threshold value) and that other wireless channels 304 (such as greater than a threshold quantity of wireless channels 304) are idle, the wireless communication device may communicate (with another wireless communication device, such as with an associated AP 102 or STA 104) via an expanded bandwidth that includes the other wireless channels 304 and that excludes the wireless channel 304 identified as busy. In other words, the wireless communication device may participate in punctured transmissions if one or more wireless channels 304 are busy while other wireless channels 304 are idle. For example, the wireless communication device may transmit a PPDU in association with puncturing the PPDU, where an expanded bandwidth via which the PPDU is transmitted excludes one or more wireless channels 304 identified (such as measured, parsed, or otherwise ascertained) to be busy. As an example, if the AP 102-a identifies that a primary subchannel associated with the wireless channel 304-c (the BSS bandwidth of the AP 102-c) is busy, the AP 102-a may transmit a 320 MHz PPDU by puncturing the wireless channel 304-c (the 80 MHZ corresponding to the BSS bandwidth of the AP 102-c). Thus, across the various implementations associated with using one or multiple auxiliary radios, one or multiple packet detectors, or a relatively energy detection threshold value for out-of-BSS wireless channels 304, wireless communication devices may be able to allow, support, enable, and facilitate PPDU puncturing if some of the wireless channels 304 are busy.

In implementations in which a first wireless communication device (such as an AP 102) has parallel energy detectors, packet detectors, or parallel auxiliary radios and in which an associated second wireless communication device (such as a STA 104) lacks parallel energy detectors, packet detectors, or parallel auxiliary radios, the first wireless communication device and the second wireless communication device may communicate in accordance with one or more signaled or configured rules. Such one or more signaled or configured rules may include a limitation or restriction of expanded bandwidth communication from the second wireless communication device to trigger based communication. For example, the one or more signaled or configured rules may include a limitation or restriction of an expanded bandwidth uplink PPDU to trigger based uplink communication. In other words, single user (SU) enhanced distributed channel access (EDCA) based uplink on an expanded bandwidth may not be permitted (or may otherwise not be expected) in scenarios in which a STA 104 lacks parallel energy detectors, packet detectors, or parallel auxiliary radios, although SU EDCA based uplink on or within a BSS bandwidth may be permitted.

Further, various wireless communication devices may support one or more signaled or configured rules associated with whether a wireless communication device is expected to count down (such as via an RBO counter) on each wireless channel 304 or if the wireless communication device may perform a PIFS energy detection check to identify whether wireless channels 304 are busy or idle. In other words, if an RBO counter on a primary subchannel of an in-BSS wireless channel 304 has expired and if the NAV on other primary subchannels of out-of-BSS wireless channels 304 has not been set, the wireless communication device may rely on one or more signaled or configured rules to identify a mode of operation.

In some implementations, the one or more signaled or configured rules may indicate or instruct the wireless communication device to perform a PIFS energy detection check to identify whether wireless channels 304 are busy or idle and may otherwise skip an RBO process on out-of-BSS wireless channels 304. In other words, if NAV is not set, and if an energy detection check indicates a wireless channel 304 is idle, the wireless channel 304 is likely idle and the bandwidth can be expanded. In some other implementations, the one or more signaled or configured rules may indicate or instruct the wireless communication device to perform an RBO process on each of the primary subchannels of the wireless channels 304. In other words, to expand a bandwidth, the wireless communication device may be expected to count down an RBO on each of the primary subchannels of the wireless channels 304 to zero at least once. In such implementations, if the wireless communication device counts down a first RBO counter on a primary subchannel of an in-BSS wireless channel 304 to zero, the wireless communication device may keep the first RBO counter at zero and continue counting down RBO counters associated with other, out-of-BSS wireless channels 304 until those RBO counters reach zero at least once (or until the wireless communication device selects to perform puncturing).

In some aspects, the wireless communication device may leverage rules associated with non-simultaneous transmit and receive (NSTR) for synchronizing PPDUs as part of such a constraint to count RBO counters down to zero at least once but extended to RBO counters associated with out-of-BSS wireless channels 304. Such NSTR synchronized PPDU rules may be associated with an enhanced distributed channel access function (EDCAF) of a STA 104 affiliated with an MLD operating on a link that is part of an NSTR link pair for that MLD following a channel access procedure. Such a channel access procedure may specify that an EDCAF of a STA 104 may initiate transmission on a link when the medium is idle as indicated by the physical and virtual carrier sensing mechanism and if the EDCAF of the STA 104 obtained an EDCA TXOP (following a specified procedure) or if a backoff counter (such as an RBO counter) of the EDCAF of the STA 104 is already zero and the EDCAF of the STA 104 operating on the other link of the NSTR link pair of the affiliated MLD obtains an EDCA TXOP (following a specified procedure). When the backoff counter of the EDCAF reaches zero, the STA 104 may select to not transmit and keep the backoff counter at zero. An EDCAF with a backoff counter that has already reached zero may initiate transmission if (such as only if) if a backoff counter (such as an RBO counter) of the EDCAF of the STA 104 is already zero and the EDCAF of the STA 104 operating on the other link of the NSTR link pair of the affiliated MLD obtains an EDCA TXOP. In some examples, an EDCAF with a backoff counter that has already reached zero and that selects to not transmit may perform a new backoff procedure following a deferral scheme before being allowed to initiate a transmission on a link following the EDCAF of the STA 104 obtaining an EDCA TXOP. In such examples, CW [AC] (a contention window for a given access category) and QSRC [AC] (a short retry counter associated with a quality of service (QOS) aware STA 104) may be left unchanged (for the new backoff procedure).

In accordance with satisfying a criteria associated with communication via an expanded bandwidth (such criteria being associated with a use of one or multiple auxiliary radios, one or multiple packet detectors, or a relatively lower energy detection threshold value for out-of-BSS wireless channels 304), a wireless communication device may communicate via a bandwidth (such as an expanded bandwidth) that includes a BSS bandwidth and one or more wireless channels 304 outside of the BSS bandwidth (such as in addition to the BSS bandwidth). For example, the AP 102-a (or another wireless communication device associated with the wireless channel 304-a) may satisfy the criteria at a first time (in association with at least an EDCA scheme 408-a on a primary subchannel of the wireless channel 304-a) and may perform communication 410-a with a STA 104 associated with the AP 102-a. Such communication 410-a may include transmission or reception of any one or more a request-to-send (RTS) frame, a multi-user (MU) RTS frame, a clear-to-send (CTS) frame, a CTS-to-self (CTS2Self) frame, a contention free (CF) end (CF-End) frame, or one or more PPDUs. In some examples, the communication 410-a may span the total available bandwidth 302. In some other examples, the communication 410-a may be punctured such that one or more wireless channels 304 are excluded from the bandwidth via which the communication 410-a is performed.

By way of further example, the AP 102-d (or another wireless communication device associated with the wireless channel 304-d) may satisfy the criteria at a second time (in association with at least an EDCA scheme 408-b on a primary subchannel of the wireless channel 304-d) and may perform communication 410-b with a STA 104 associated with the AP 102-d. Such communication 410-b may include transmission or reception of any one or more of an RTS frame, an MU-RTS frame, a CTS frame, a CTS2Self frame, a CF-End frame, or one or more PPDUs. The communication 410-b may span the total available bandwidth 302 or may be punctured such that one or more wireless channels 304 are excluded from the bandwidth via which the communication 410-b is performed.

In some examples, the communication 410-a and the communication 410-b may start with non-HT duplicate RTS/CTS frames (such as a non-HT duplicate RTS/CTS frame exchange) across the total available bandwidth 302 (such as on all BSS channels). For example, RTS and CTS frames may be duplicated on at least each primary subchannel of the wireless channels 304. In some examples, the RTS and CTS frames may be duplicated on each subchannel (primary and non-primary) of the wireless channels 304. In accordance with such a non-HT duplicate RTS/CTS frame exchange on all BSS channels, various other wireless communication devices may receive one or more of the RTS frame or the CTS frame and may set a NAV counter in accordance with the duration indicated by the RTS frame or the CTS frame. In other words, the RTS/CTS frame exchange may set the NAV on all BSS channels (such as on all wireless channels 304 of the total available bandwidth 302), which may prevent or reduce the likelihood of inter-channel (such as inter-BSS) hidden node issues.

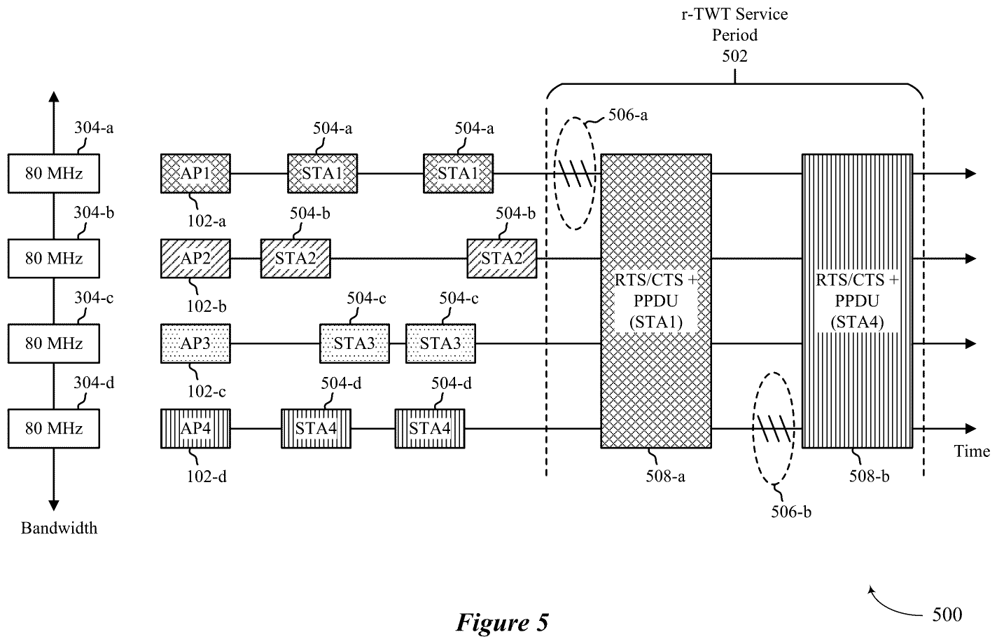

FIG. 5 shows an example communication timeline 500 that supports dynamic bandwidth expansion. The communication timeline 500 may implement or be implemented to realize one or more aspects of the wireless communication network 100, the wireless communication network 200, and the wireless communication network 300. For example, the communication timeline 500 illustrates communication between various APs 102 and various associated STAs 104, which may be examples of corresponding devices as illustrated by and described with reference to FIGS. 1-3. In some implementations, the various APs 102 and various associated STAs 104 may support one or more configuration- or signaling-based mechanisms associated with dynamic (BSS) bandwidth expansion.

In some examples, each AP 102 (and any associated wireless communication devices, including one or more STAs 104) may establish (such as negotiate, configure, allocate, transmit or receive information indicative of, or otherwise use) a respective wireless communication link associated with a respective wireless channel 304 (such as a respective BSS bandwidth of that AP 102). For example, the AP 102-a may establish the wireless channel 304-a as a BSS bandwidth of the AP 102-a, the AP 102-b may establish the wireless channel 304-b as a BSS bandwidth of the AP 102-b, the AP 102-c may establish the wireless channel 304-c as a BSS bandwidth of the AP 102-c, and the AP 102-d may establish the wireless channel 304-d as a BSS bandwidth of the AP 102-d. Likewise, a STA 104 associated with the AP 102-a may establish a wireless communication link using the wireless channel 304-a, a STA 104 associated with the AP 102-b may establish a wireless communication link using the wireless channel 304-b, a STA 104 associated with the AP 102-c may establish a wireless communication link using the wireless channel 304-c, and a STA 104 associated with the AP 102-d may establish a wireless communication link using the wireless channel 304-d.

The wireless channel 304-a, the wireless channel 304-b, the wireless channel 304-c and the wireless channel 304-d may be examples of the corresponding wireless channels 304 as illustrated by and described with reference to FIG. 3. For example, the wireless channel 304-a, the wireless channel 304-b, the wireless channel 304-c and the wireless channel 304-d may be different portions of bandwidth from a total available bandwidth 302. The wireless channel 304-a, the wireless channel 304-b, the wireless channel 304-c and the wireless channel 304-d may be contiguous or noncontiguous.

The APs 102 may communicate with one or more associated STAs 104 via a BSS bandwidth (such as via any one or more subchannels within a BSS bandwidth). Such communication may include one or both of transmission or reception of one or more packets, such as Wi-Fi packets or PPDUs. For example, the AP 102-a may communicate one or more packets 504-a with one or more STAs 104 associated with the AP 102-a, the AP 102-b may communicate one or more packets 504-b with one or more STAs 104 associated with the AP 102-b, the AP 102-c may communicate one or more packets 504-c with one or more STAs 104 associated with the AP 102-c, and the AP 102-d may communicate one or more packets 504-d with one or more STAs 104 associated with the AP 102-d.

In some implementations, a wireless communication device (such an AP 102 or a STA 104) may support or perform expanded bandwidth transmissions within or at specific time periods, time epochs, or service periods and may refrain from supporting or performing expanded bandwidth transmissions outside of such specific time periods, time epochs, or service periods. For example, the wireless communication device may support (such as configure, identify, or communicate information indicative of) a restricted target wake time (TWT) (r-TWT) schedule associated with a set of r-TWT service periods 502. In such examples, the set of r-TWT service periods 502 may be protected (such as exclusive) for communication via an expanded bandwidth that includes an in-BSS wireless channel 304 and one or more wireless channels 304 outside of the BSS bandwidth. In some examples, the set of r-TWT service periods 502 may be understood as being protected for communication via an expanded bandwidth in accordance with one or more rules according to which wireless communication devices may vacate respective wireless channels 304 before the start of an (such as each) r-TWT service period 502 of the set of r-TWT service periods 502. As described herein, an r-TWT service period associated with the expanded bandwidth communication may be understood as a dynamic bandwidth service period.

In some implementations, the r-TWT schedule may be associated with or otherwise referred to as a coordinated r-TWT (C-r-TWT)-based expanded BSS. For example, the APs 102 may communicate (such as transmit or receive) one or more frames as part of a negotiation of the r-TWT schedule. In other words, the APs 102 may coordinate or negotiate on the r-TWT schedule. In such implementations, the C-r-TWT negotiation may be between neighboring APs 102 on different wireless channels 304. In accordance with coordinating on the r-TWT schedule, each AP 102 may transmit information indicative of the r-TWT schedule (such as via one or more management frames, such as via one or more beacon frames). In examples in which an r-TWT service period may be understood as a dynamic bandwidth service period, a management frame (such as a beacon frame) may indicate one or more dynamic bandwidth service periods (which may be associated with one or more time periods or time epochs), such as by including information indicative of the r-TWT schedule. In this manner, STAs 104 associated with each AP 102 may receive (such as via a management frame) information indicative of the r-TWT schedule (such as a dynamic bandwidth service period). In some aspects, the information indicative of the r-TWT schedule may indicate that the r-TWT schedule is associated with (such as purposed or configured for) expanded bandwidth communication. Additionally, or alternatively, the information may indicate that the r-TWT schedule is accessible (such as usable) by wireless communication devices having a specified capability (such as a capability for expanded bandwidth communication).

Additionally, or alternatively, the information or one or more other rules (such as one or more configured rules, such as rules associated with a network specification) may indicate how wireless communication devices may be expected to contend for channel access during the set of r-TWT service periods 502. In some implementations, the information or other rule(s) may indicate that a primary subchannel in each BSS bandwidth (such as in each wireless channel 304) may remain the same during r-TWT service periods 502 associated with the r-TWT schedule. In such implementations, each BSS that has data to transmit may restart an RBO counter (such as a backoff counter) on a corresponding primary subchannel at the beginning of an r-TWT service period 502 (where the r-TWT schedule may ensure or increase the likelihood that there are no ongoing transmissions at the beginning of the r-TWT service period 502).

For example, at the beginning of the r-TWT service period 502, at least a first wireless communication device associated with the wireless channel 304-a (such as the AP 102-a or a STA 104 associated with the AP 102-a) and at least a second wireless communication device associated with the wireless channel 304-d (such as the AP 102-d or a STA 104 associated with the AP 102-d) may have data to transmit and, in some implementations, each of such at least two wireless communication devices may (re) start a respective RBO counter in an attempt to obtain channel access during the r-TWT service period 502. In some examples, a first RBO counter at the first wireless communication device may expire before a second RBO counter at the second wireless communication device and, accordingly, the first wireless communication device may obtain channel access during the r-TWT service period 502 prior to the second wireless communication device. In such examples, the first wireless communication device may, in accordance with an EDCA scheme 506-a on (a primary subchannel of) the wireless channel 304-a, perform communication 508-a via an expanded bandwidth that includes the wireless channel 304-a (a BSS bandwidth of the first wireless communication device) and one or more wireless channels 304 outside of the BSS bandwidth. The second wireless communication device may obtain channel access after the first wireless communication device and, in accordance with an EDCA scheme 506-b on (a primary subchannel of) the wireless channel 304-d, perform communication 508-b via an expanded bandwidth that includes the wireless channel 304-d (a BSS bandwidth of the second wireless communication device) and one or more wireless channels 304 outside of the BSS bandwidth.

Such communication 508-a and communication 508-b may include one or more of various frames or packets. For example, the communication 508-a or the communication 508-b may include transmission or reception of any one or more of an RTS frame, an MU-RTS frame, a CTS frame, a CTS2Self frame, a CF-End frame, or one or more PPDUs. In some implementations, a wireless communication device may refrain from transmitting a CTS2Self frame for purpose of granting sufficient time to switch a radio (such as the main radio) of the wireless communication to the expanded bandwidth in accordance with having advance knowledge of the r-TWT schedule. In other words, in accordance with using an r-TWT schedule, a wireless communication device may expand its bandwidth (at its main radio) in advance of a start of a service period. The communication 508-a or the communication 508-b may span the total available bandwidth 302 or may be punctured such that one or more wireless channels 304 are excluded from the bandwidth via which the communication 508-a or the communication 508-b is performed (such as in accordance with an energy level value of the punctured wireless channel(s) 304 failing to satisfy threshold value, if measured). In some examples, a wireless communication device may refrain from puncturing the communication 508-a or the communication 508-b in accordance with using the r-TWT schedule and monitoring a primary subchannel (and refraining from monitoring other channels or subchannels).

In some implementations, transmissions within an r-TWT service period 502 may start with non-HT duplicate RTS/CTS frames (such as a non-HT duplicate RTS/CTS frame exchange) across the total available bandwidth 302 (such as on all BSS channels). For example, RTS and CTS frames may be duplicated on at least each primary subchannel of the wireless channels 304. In some examples, the RTS and CTS frames may be duplicated on each subchannel (primary and non-primary) of the wireless channels 304. In accordance with such a non-HT duplicate RTS/CTS frame exchange on all BSS channels, various other wireless communication devices may receive one or more of the RTS frame or the CTS frame and may set a NAV counter in accordance with the duration indicated by the RTS frame or the CTS frame. In other words, the RTS/CTS frame exchange may set the NAV on all BSS channels (such as on all wireless channels 304 of the total available bandwidth 302), which may prevent or reduce the likelihood of inter-channel (such as inter-BSS) hidden node issues.

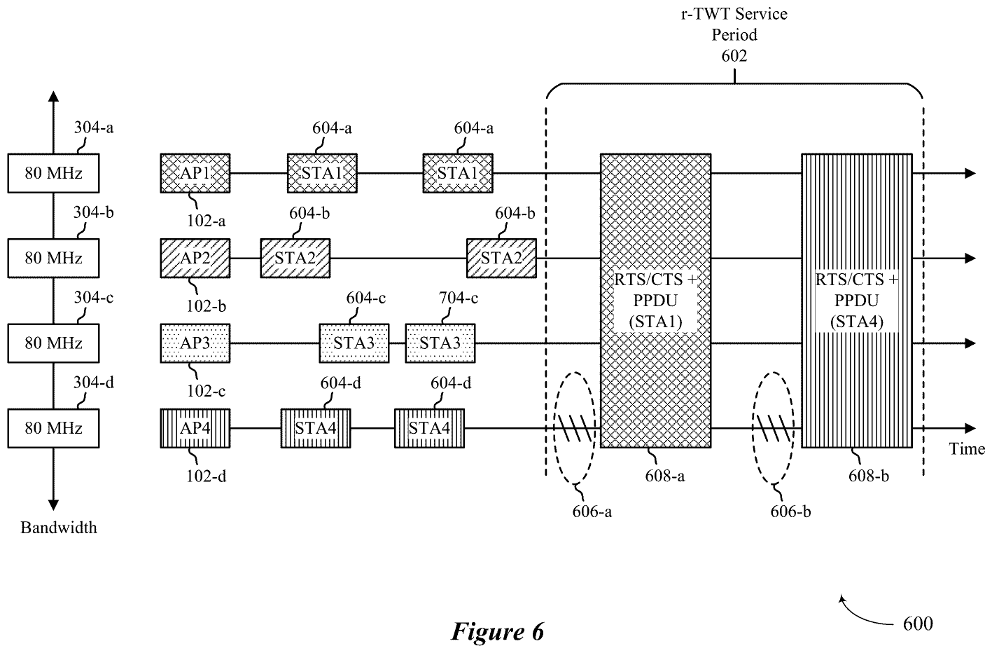

FIG. 6 shows an example communication timeline 600 that supports dynamic bandwidth expansion. The communication timeline 600 may implement or be implemented to realize one or more aspects of the wireless communication network 100, the wireless communication network 200, and the wireless communication network 300. For example, the communication timeline 600 illustrates communication between various APs 102 and various associated STAs 104, which may be examples of corresponding devices as illustrated by and described with reference to FIGS. 1-3. In some implementations, the various APs 102 and various associated STAs 104 may support one or more configuration- or signaling-based mechanisms associated with dynamic (BSS) bandwidth expansion. In some implementations, the communication timeline 600 may leverage an r-TWT schedule associated with a set of r-TWT service periods 602, which may be examples of the r-TWT service periods 502 as illustrated by and described with reference to FIG. 5.

The APs 102 may communicate with one or more associated STAs 104 via a BSS bandwidth (such as via any one or more subchannels within a BSS bandwidth). Such communication may include one or both of transmission or reception of one or more packets, such as Wi-Fi packets or PPDUs. For example, the AP 102-a may communicate one or more packets 604-a with one or more STAs 104 associated with the AP 102-a, the AP 102-b may communicate one or more packets 604-b with one or more STAs 104 associated with the AP 102-b, the AP 102-c may communicate one or more packets 604-c with one or more STAs 104 associated with the AP 102-c, and the AP 102-d may communicate one or more packets 604-d with one or more STAs 104 associated with the AP 102-d.

In some implementations, a wireless communication device (such an AP 102 or a STA 104) may support or perform expanded bandwidth transmissions within or at specific time periods, time epochs, or service periods and may refrain from supporting or performing expanded bandwidth transmissions outside of such specific time periods, time epochs, or service periods. For example, the wireless communication device may support (such as configure, identify, or communicate information indicative of) an r-TWT schedule associated with a set of r-TWT service periods 602. In such examples, the set of r-TWT service periods 602 may be protected (such as exclusive) for communication via an expanded bandwidth that includes an in-BSS wireless channel 304 and one or more wireless channels 304 outside of the BSS bandwidth, as illustrated by and described in more detail with reference to FIG. 5. Further, two or more APs 102 may negotiate or coordinate on the r-TWT schedule associated with the set of r-TWT service periods 602, as also described in more detail herein, including with reference to FIG. 5.

In some implementations, the information or one or more other rules (such as one or more configured rules, such as rules associated with a network specification) may indicate how wireless communication devices may be expected to contend for channel access during the set of r-TWT service periods 602. In some implementations, the information or other rule(s) may indicate that all wireless communication devices (such as all BSSs) with data to transmit may switch to a single (such as a same) primary subchannel during each r-TWT service period 602 of the schedule of r-TWT service periods 602. For example, and as illustrated in the example of FIG. 6, a first wireless communication device associated with the wireless channel 304-a (such as the AP 102-a or a STA 104 associated with the AP 102-a) and at least a second wireless communication device associated with the wireless channel 304-d (such as the AP 102-d or a STA 104 associated with the AP 102-d) may have data to transmit and, accordingly, may switch to a same primary subchannel. Such a same primary subchannel may be, for example, a primary subchannel of the wireless channel 304-d. The information indicative of the r-TWT schedule may include identifying information of the primary subchannel of the wireless channel 304-d.

Further, each wireless communication device (such as one or more BSSs, or every BSS) that has data to transmit may (re) start a respective RBO counter on the single primary subchannel at the beginning of an r-TWT service period 602. In some implementations, the r-TWT schedule may increase the likelihood that there are no ongoing transmissions at the beginning of the r-TWT service period 602. In some examples, a first RBO counter at the first wireless communication device may expire before a second RBO counter at the second wireless communication device and, accordingly, the first wireless communication device may obtain channel access during the r-TWT service period 602 prior to the second wireless communication device. In such examples, the first wireless communication device may, in accordance with an EDCA scheme 606-a on (a primary subchannel of) the wireless channel 304-d (which the first wireless communication device may switch to at the beginning of the r-TWT service period 602), perform communication 608-a via an expanded bandwidth that includes the wireless channel 304-a (a BSS bandwidth of the first wireless communication device) and one or more wireless channels 304 outside of the BSS bandwidth. The second wireless communication device may obtain channel access after the first wireless communication device and, in accordance with an EDCA scheme 606-b on (a primary subchannel of) the wireless channel 304-d, perform communication 608-b via an expanded bandwidth that includes the wireless channel 304-d (a BSS bandwidth of the second wireless communication device) and one or more wireless channels 304 outside of the BSS bandwidth.

Such communication 608-a and communication 608-b may include one or more of various frames or packets. For example, the communication 608-a or the communication 608-b may include transmission or reception of any one or more of an RTS frame, an MU-RTS frame, a CTS frame, a CTS2Self frame, a CF-End frame, or one or more PPDUs. The communication 608-a or the communication 608-b may span the total available bandwidth 302 or may be punctured such that one or more wireless channels 304 are excluded from the bandwidth via which the communication 608-a or the communication 608-b is performed (such as in accordance with an energy level value of the punctured wireless channel(s) 304 failing to satisfy threshold value, if measured).

In some implementations, transmissions within an r-TWT service period 602 may start with non-HT duplicate RTS/CTS frames (such as a non-HT duplicate RTS/CTS frame exchange) across the total available bandwidth 302 (such as on all BSS channels). For example, RTS and CTS frames may be duplicated on at least each primary subchannel of the wireless channels 304. In some examples, the RTS and CTS frames may be duplicated on each subchannel (primary and non-primary) of the wireless channels 304. In accordance with such a non-HT duplicate RTS/CTS frame exchange on all BSS channels, various other wireless communication devices may receive one or more of the RTS frame or the CTS frame and may set a NAV counter in accordance with the duration indicated by the RTS frame or the CTS frame. In other words, the RTS/CTS frame exchange may set the NAV on all BSS channels (such as on all wireless channels 304 of the total available bandwidth 302), which may prevent or reduce the likelihood of inter-channel (such as inter-BSS) hidden node issues.

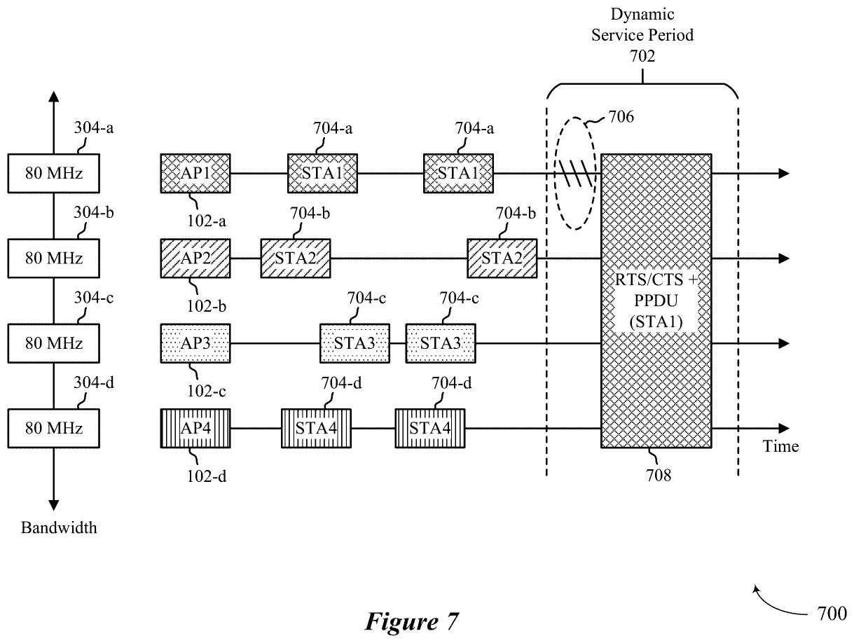

FIG. 7 shows an example communication timeline 700 that supports dynamic bandwidth expansion. The communication timeline 700 may implement or be implemented to realize one or more aspects of the wireless communication network 100, the wireless communication network 200, and the wireless communication network 300. For example, the communication timeline 700 illustrates communication between various APs 102 and various associated STAs 104, which may be examples of corresponding devices as illustrated by and described with reference to FIGS. 1-3. In some implementations, the various APs 102 and various associated STAs 104 may support one or more configuration- or signaling-based mechanisms associated with dynamic (BSS) bandwidth expansion.

In some examples, each AP 102 (and any associated wireless communication devices, including one or more STAs 104) may establish (such as negotiate, configure, allocate, transmit or receive information indicative of, or otherwise use) a respective wireless communication link associated with a respective wireless channel 304 (such as a respective BSS bandwidth of that AP 102). For example, the AP 102-a may establish the wireless channel 304-a as a BSS bandwidth of the AP 102-a, the AP 102-b may establish the wireless channel 304-b as a BSS bandwidth of the AP 102-b, the AP 102-c may establish the wireless channel 304-c as a BSS bandwidth of the AP 102-c, and the AP 102-d may establish the wireless channel 304-d as a BSS bandwidth of the AP 102-d. Likewise, a STA 104 associated with the AP 102-a may establish a wireless communication link using the wireless channel 304-a, a STA 104 associated with the AP 102-b may establish a wireless communication link using the wireless channel 304-b, a STA 104 associated with the AP 102-c may establish a wireless communication link using the wireless channel 304-c, and a STA 104 associated with the AP 102-d may establish a wireless communication link using the wireless channel 304-d.

The wireless channel 304-a, the wireless channel 304-b, the wireless channel 304-c and the wireless channel 304-d may be examples of the corresponding wireless channels 304 as illustrated by and described with reference to FIG. 3. For example, the wireless channel 304-a, the wireless channel 304-b, the wireless channel 304-c and the wireless channel 304-d may be different portions of bandwidth from a total available bandwidth 302. The wireless channel 304-a, the wireless channel 304-b, the wireless channel 304-c and the wireless channel 304-d may be contiguous or noncontiguous.

The APs 102 may communicate with one or more associated STAs 104 via a BSS bandwidth (such as via any one or more subchannels within a BSS bandwidth). Such communication may include one or both of transmission or reception of one or more packets, such as Wi-Fi packets or PPDUs. For example, the AP 102-a may communicate one or more packets 704-a with one or more STAs 104 associated with the AP 102-a, the AP 102-b may communicate one or more packets 704-b with one or more STAs 104 associated with the AP 102-b, the AP 102-c may communicate one or more packets 704-c with one or more STAs 104 associated with the AP 102-c, and the AP 102-d may communicate one or more packets 704-d with one or more STAs 104 associated with the AP 102-d.

In some implementations, a wireless communication device (such an AP 102 or a STA 104) may support or perform expanded bandwidth transmissions in accordance with employing one or more dynamic service periods 702 (such as one or more dynamic time periods). For example, the wireless communication device may support expanded bandwidth transmissions within specific service periods (and may not support expanded bandwidth transmissions outside of such specific service periods) and such service periods may be dynamically or opportunistically scheduled in accordance with frame signaling or a frame exchange. Such frame signaling may be via any example frames described herein, including a management frame or a control frame, among other examples. In some implementations, such service periods may be scheduled in accordance with a control frame exchange. In some other implementations, a dynamic service period 702 may be activated or deactivated (such as enabled or disabled) via one or more management frames.

For example, to indicate a start or schedule such a dynamic service period 702 (such as an expanded bandwidth service period), a wireless communication device may transmit a first frame (such as a first control frame or a first management frame) signaling an expanded bandwidth. In some implementations, the wireless communication device may initiate the dynamic service period 702 in accordance with NAV information (such as NAV counters) on the primary subchannels of out-of-BSS wireless channels 304 or in accordance with performing energy detection-based RBO on the primary subchannels of out-of-BSS wireless channels 304. In other words, the wireless communication device may initiate the dynamic service period 702 by transmitting the first frame in accordance with NAV information or in association with performing energy detection based RBO on the other primary subchannels.

Such a first frame may be a CTS2Self frame or a CF-End frame. In implementations in which the first control frame is a CTS2Self frame, the wireless communication device may transmit the CTS2Self frame via the total available bandwidth 302 (such as 320 MHz, and in or via a non-HT duplicate PPDU) with the bandwidth signaling receiver address (RA) and a field (such as a service field) indicating 320 MHz (such as to announce that a forthcoming transmission may span the 320 MHz bandwidth). In other words, and generally, if the expanded bandwidth is X MHz, the wireless communication device may transmit the CTS2Self frame via the X MHz and a bandwidth signaling RA may indicate X 320 MHz.

In implementations in which the first frame is a CF-End frame, the wireless communication device may transmit a CF-End frame via the total available bandwidth 302 (such as 320 MHz, and in or via a non-HT duplicate PPDU) with a bandwidth signaling RA and a field (such as a service field) indicating 320 MHz. In some aspects, in accordance with using a CF-End frame, the wireless communication device may reset an intra-BSS NAV. Additionally, or alternatively, the wireless communication device may set a transmitter address (TA) field of the CF-End frame to an address other than its BSSID to force (such as trigger, initiate, or indicate) a resetting of one or multiple inter-BSS NAVs. Such a setting of the TA field may be associated with a changing, by the wireless communication device, of one or more bits (such as a single bit) from a BSSID field of the CF-End frame. In some aspects, resetting one or more NAVs may enable various wireless communication devices (such as non-AP STAs, such as low-latency STAs 104) to contend and flush their respective PPDUs in the expanded bandwidth.

In accordance with starting or scheduling the dynamic service period 702, the wireless communication device may communicate via an expanded bandwidth that includes a BSS bandwidth and one or more wireless channels 304 outside of the BSS bandwidth. For example, the wireless communication device (such as an AP 102 or a STA 104) may, in accordance with an EDCA scheme 706 on (a primary subchannel of) the wireless channel 304-a, perform communication 708 via an expanded bandwidth that includes the wireless channel 304-a (a BSS bandwidth of the wireless communication device) and one or more wireless channels 304 outside of the BSS bandwidth. Such communication 708 may include one or more of various frames or packets. For example, the communication 708 may include transmission or reception of any one or more of an RTS frame, an MU-RTS frame, a CTS frame, a CTS2Self frame (such as the first control frame), a CF-End frame (such as the first control frame), or one or more PPDUs. The communication 708 may span the total available bandwidth 302 or may be punctured such that one or more wireless channels 304 are excluded from the bandwidth via which the communication 708 is performed (such as in accordance with an energy level value of the punctured wireless channel(s) 304 failing to satisfy threshold value, if measured).

To indicate an end of the dynamic service period 702, the wireless communication device may transmit a second frame (such as a second control frame or a second management frame). In some implementations, the second frame may signal (such as indicate) a BSS bandwidth to indicate the end of the dynamic service period 702 (such as the expanded bandwidth service period). The second frame may be a CTS2Self frame sent via the BSS bandwidth (in or via a non-HT duplicate PPDU) with a bandwidth signaling RA and a field (such as a service field) indicating the BSS bandwidth.

In some implementations, within the dynamic service period 702, one or more STAs 104 associated with an AP 102 (such as the AP 102 that starts and ends the dynamic service period 702, such as the AP 102-a) may refrain from tracking the NAV or performing energy detection at a relatively lower threshold value on other primary subchannels (such as primary subchannels associated with out-of-BSS wireless channels 304). For example, a STA 104 associated with the AP 102-a may refrain from tracking the NAV or performing energy detection at a relatively lower threshold value on the primary subchannels of the wireless channel 304-b, the wireless channel 304-c, and the wireless channel 304-d (for a duration of the dynamic service period 702). The STA 104 may continue monitoring (and tracking or maintaining NAV) the primary subchannel of the wireless channel 304-a.

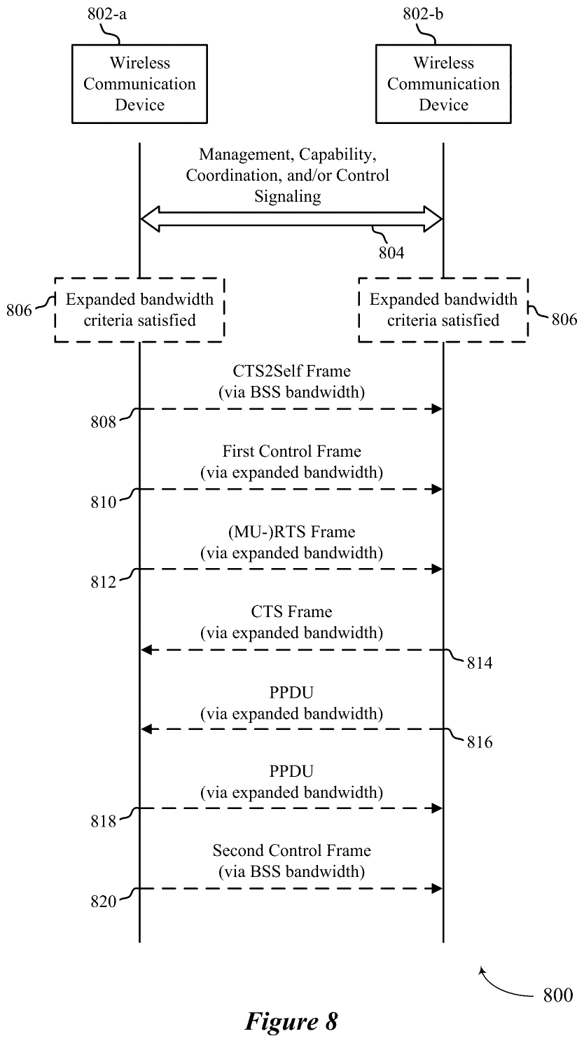

FIG. 8 shows an example process flow 800 that supports dynamic bandwidth expansion. The process flow 800 may implement or be implemented to realize one or more aspects of the wireless communication network 100, the wireless communication network 200, the wireless communication network 300, or any one or more of the communication timeline 400, the communication timeline 500, the communication timeline 600, or the communication timeline 700 (separately or in any combination). For example, the process flow 800 illustrates communication between two wireless communication devices including a wireless communication device 802-a and a wireless communication device 802-b, which may be examples of corresponding devices as illustrated by and described with reference to FIGS. 1-7. In some implementations, the wireless communication devices may support one or more configuration- or signaling-based mechanisms associated with dynamic (BSS) bandwidth expansion.

In the following description of the process flow 800, the operations may be performed (such as reported or provided) in a different order than the order shown, or the operations performed by the example devices may be performed in different orders or at different times. Some operations also may be left out of the process flow 800, or other operations may be added to the process flow 800. Further, although some operations or signaling may be shown to occur at different times for discussion purposes, these operations may actually occur at the same time.

At 804, the wireless communication device 802-a and the wireless communication device 802-b (among potentially other wireless communication devices) may communicate (such as transmit or receive) management, capability, coordination, or control signaling, or any combination thereof. Generally, “communicating” may refer to one or both of transmitting or receiving. In some implementations, the management, capability, coordination, or control signaling may indicate an r-TWT schedule or one or more threshold values associated with a criteria to communicate via an expanded bandwidth. Additionally, or alternatively, the wireless communication device 802-a and the wireless communication device 802-b may communicate information indicative of an expanded bandwidth. For example, a management frame, such as a beacon frame, may include information indicative of an expanded bandwidth. In such examples, the wireless communication device 802-a and the wireless communication device 802-b may communicate a frame including a first field and a second field, with the first field indicating a baseline or default bandwidth (such as 80 MHz) and with the second field indicating an expanded bandwidth (such as 320 MHz). In other words, in addition to the default bandwidth, wireless communication devices may transmit or receive information indicative of the expanded bandwidth.

In some examples, the expanded bandwidth may be semi-statically indicated or configured by at least one of the wireless communication device 802-a and the wireless communication device 802-b. For example, an AP 102 may sometimes operate with or support a 320 MHz expanded bandwidth and may, at other times, operate with or support a 160 MHz expanded bandwidth. In some examples, at least one of the wireless communication device 802-a and the wireless communication device 802-b may enable or disable an expanded bandwidth mode. For example, at least one of the wireless communication device 802-a and the wireless communication device 802-b may set the second field to indicate a same bandwidth as the default bandwidth to (effectively) disable the expanded bandwidth mode.

Additionally, or alternatively, expanded bandwidth communication may be associated with a mode of operation. In such examples, at least one of the wireless communication device 802-a and the wireless communication device 802-b may transmit an indication of an activation or a deactivation (such as an enablement or a disablement) of the mode of operation (such as via or using management frame signaling). In other words, the mode of operation associated with expanded bandwidth communication may be enabled or disabled by a wireless communication device (such as an AP 102 or a non-AP STA 104) using management frame signaling). For example, a first management frame, such as a first beacon frame, may indicate an enablement of an expanded bandwidth (such as for a time period, such as for a period of expanded bandwidth operation). In such examples, the first management frame may indicate, for example, an operating bandwidth of 320 MHz for the period of expanded bandwidth operation. A second management frame, such as a second beacon frame, may indicate a disablement of the expanded bandwidth. In such examples, the time period (such as the period of expanded bandwidth operation) may span from the first management frame (such as the first beacon frame) to the second management frame (such as the second beacon frame). Additionally, or alternatively, at least one of the wireless communication device 802-a and the wireless communication device 802-b may transmit information indicating that expanded bandwidth communication (such as dynamic channel expansion) is associated with (such as restricted to) one or more specific access categories (ACs). In such examples, for instance, data or communication associated with the one or more specified ACs may leverage expanded bandwidth communication and data or communication not associated with the one or more specified ACs may not leverage expanded bandwidth communication.

At 806, at least one of the wireless communication device 802-a and the wireless communication device 802-b may measure, identify, receive information indicative of, ascertain, or otherwise determine that a criteria associated with expanded bandwidth communication is satisfied. Such a criteria may be associated with a use of one or multiple auxiliary radios, one or multiple packet detectors, a relatively lower energy detection threshold value for out-of-BSS wireless channels 304, an r-TWT schedule, or a scheduling of one or more dynamic service periods, as illustrated and described in more detail herein, including by and with reference to FIGS. 3-7.

At 808, in some implementations, the wireless communication device 802-a may transmit a CTS2Self frame via a BSS bandwidth of the wireless communication device 802-a. In some aspects, the wireless communication device 802-a may transmit the CTS2Self frame to accommodate a switching time associated with a dynamic bandwidth expansion (such as a dynamic expansion from 80 MHz to 320 MHZ). To accommodate such a switching time at a receiver of the expanded bandwidth communication, a transmitter may provide padding via the initial control frame (ICF), such as via an MU-RTS frame. To accommodate the switching time at the transmitter, the wireless communication device 802-a (the transmitter) may transmit the CTS2Self frame.

The wireless communication device 802-a may transmit the CTS2Self frame via its BSS bandwidth and may indicate a duration (such as for NAV setting) in the CTS2Self frame in accordance with the switching time. In some examples, the wireless communication device 802-a may set the duration indicated by the CTS2Self frame (via a Duration field) to a value greater than the time taken by the transmitter to expand the bandwidth via which one or more radios or antennas of the wireless communication device 802-a are configured to communicate. Additionally, or alternatively, the wireless communication device 802-a may set the Duration field of the CTS2Self frame to a value equal to a switching time minus a SIFS duration (such as minus 16 microseconds). For example, wireless communication devices may refrain from contending for channel access SIFS after the CTS2Self frame. Thus, the wireless communication device 802-a may use the SIFS duration (the 16 microseconds) for bandwidth expansion without a risk of any other wireless communication device overtaking the medium.

In some aspects, the wireless communication device 802-a may initiate the bandwidth expansion approximately immediately after transmitting the CTS2Self frame and may complete the bandwidth expansion before the time indicated by the Duration (NAV) field of the CTS2Self frame. In accordance with completing the bandwidth expansion, the wireless communication device 802-a may transmit a non-HT duplicated RTS frame in or via the expanded bandwidth prior to expiry of the NAV to initiate a TXOP on the expanded bandwidth. In some implementations, if the wireless communication device 802-a is able to expand its bandwidth in 16 microseconds or less, the wireless communication device 802-a may transmit a CF-End frame instead of the CTS2Self frame. Additionally, or alternatively, the wireless communication device 802-a may perform bandwidth expansion during the in-BSS transmission (such as within the duration set by the CTS2Self frame) and may subsequently transmit one or more PPDUs (such as non-HT duplicated RTS and beyond) using the expanded bandwidth.

At 810, in some implementations, the wireless communication device 802-a may transmit a first control frame via the expanded bandwidth. Such a first control frame may be a CTS2Self frame or a CF-End frame. In some implementations, the wireless communication device 802-a may transmit the first control frame in association with starting a dynamic service period, such as a dynamic service period 702 as illustrated by and described with reference to FIG. 7. In some aspects, the first control frame may (at least partially) protect the dynamic service period for expanded bandwidth communication. Additionally, or alternatively, the wireless communication device 802-a may transmit an RTS or MU-RTS frame on the expanded bandwidth (after starting the dynamic service period) and the RTS or MU-RTS frame may effectively protect (at least a remainder of) the dynamic service period for expanded bandwidth communication.

At 812, in some implementations, the wireless communication device 802-a may transmit an (MU-) RTS frame via the expanded bandwidth. In some implementations, the wireless communication device 802-a may transmit the RTS or MU-RTS frame via the expanded bandwidth to protect the expanded bandwidth for upcoming PPDU transmissions between the wireless communication device 802-a and the wireless communication device 802-b. In some aspects, the wireless communication device 802-a and the wireless communication device 802-b may use an MU-RTS/CTS frame exchange instead of, for example, an RTS/CTS frame exchange, as an initial frame exchange via the expanded bandwidth if the receiver expects some amount of padding delay to expand its bandwidth. In some implementations, the (MU-) RTS frame may be a trigger frame soliciting an expanded bandwidth transmission from the wireless communication device 802-b. In some other implementations, the wireless communication device 802-a may transmit a separate trigger frame to the wireless communication device 802-b to solicit an expanded bandwidth transmission from the wireless communication device 802-b. In some other implementations, the wireless communication device 802-a may not transmit a trigger frame soliciting an expanded bandwidth transmission from the wireless communication device 802-b (and instead may transmit to the wireless communication device 802-b).

At 814, in some implementations, the wireless communication device 802-b may transmit a CTS frame. Such a CTS frame may be associated with, such as responsive to, the (MU-) RTS frame transmitted by the wireless communication device 802-a at 812.

At 816, in some implementations, the wireless communication device 802-b may transmit a PPDU to the wireless communication device 802-a via the expanded bandwidth. The PPDU may span an entirety of the expanded bandwidth or may be punctured such that one or more wireless channels are excluded from the expanded bandwidth.

At 818, in some implementations, the wireless communication device 802-a may transmit a PPDU to the wireless communication device 802-b via the expanded bandwidth. The PPDU may span an entirety of the expanded bandwidth or may be punctured such that one or more wireless channels are excluded from the expanded bandwidth.

At 820, in some implementations, the wireless communication device 802-a may transmit a second control frame. In some implementations, the wireless communication device 802-a may transmit the second control frame in association with ending a dynamic service period. The second control frame may be a CTS2Self frame sent via a BSS bandwidth (in an non-HT duplicate PPDU) with a bandwidth signaling RA and a field (such as a service field) indicating the BSS bandwidth.

Further, in some implementations, the wireless communication device 802-a and the wireless communication device 802-b may use one or more other modes in conjunction with an expanded BSS bandwidth mode. For example, if a non-AP STA 104 lacks support for the expanded BSS bandwidth, an AP 102 may use dynamic subchannel operation (DSO) and assign resources, via the DSO ICF, to the non-AP STA 104 in a secondary wireless channel 304 of the expanded BSS bandwidth (such as of the total available bandwidth 302). Additionally, or alternatively, if a primary subchannel of a BSS bandwidth is ascertained to be busy, an AP 102 or a STA 104 may perform NPCA to utilize a remaining bandwidth (such as one or more out-of-BSS wireless channels 304) of the expanded BSS bandwidth (such as of the total available bandwidth 302) for performing one or more frame exchanges. Additionally, or alternatively, if a non-AP STA 104 performs or supports enhanced multi-link single radio (EMLSR) operation on one or more EMLSR links of a non-AP MLD, an AP 102 may transmit a trigger frame (such as an MU-RTS Trigger frame or a buffer status report poll (BSRP) Trigger frame) on the expanded bandwidth (such as on the total available bandwidth 302). In such examples, the non-AP STA 104 may switch to a corresponding link and respond (such as with a CTS or a buffer status report (BSR), respectively) via the expanded bandwidth (such as via the total available bandwidth 302).

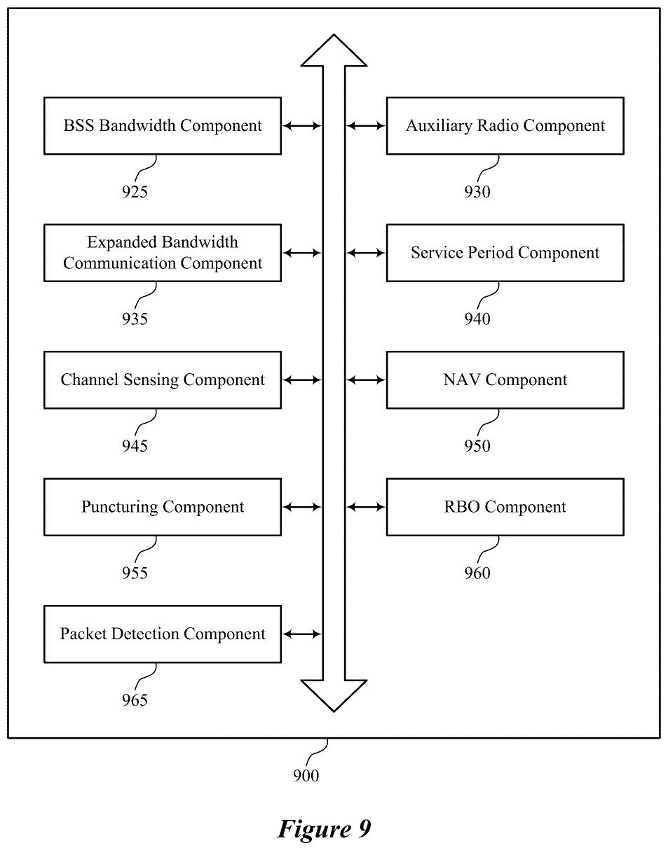

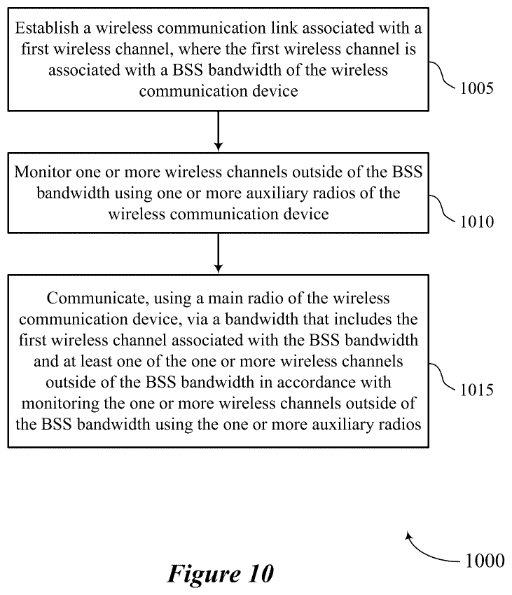

FIG. 9 shows a block diagram of an example wireless communication device 900 that supports dynamic bandwidth expansion. In some examples, the wireless communication device 900 is configured to perform the processes 1000, 1100, and 1200 described with reference to FIGS. 10, 11, and 12, respectively. The wireless communication device 900 may include one or more chips, SoCs, chipsets, packages, components or devices that individually or collectively constitute or include a processing system. The processing system may interface with other components of the wireless communication device 900, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 900 may transmit the information output from the chip. In such an example, the second interface may refer to an interface between the processing system of the chip and a reception component, such that the wireless communication device 900 may receive information that is then passed to the processing system. In some such examples, the first interface also may obtain information, such as from the transmission component, and the second interface also may output information, such as to the reception component.

The processing system of the wireless communication device 900 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 900 can be configurable or configured for use in an AP or STA, such as the AP 102 or the STA 104 described with reference to FIG. 1. In some other examples, the wireless communication device 900 can be an AP or STA that includes such a processing system and other components including multiple antennas. The wireless communication device 900 is capable of transmitting and receiving wireless communications in the form of, for example, wireless packets. For example, the wireless communication device 900 can be configurable or configured to transmit and receive packets in the form of physical layer PPDUs and MPDUs conforming to one or more of the IEEE 802.11 family of wireless communication protocol standards. In some other examples, the wireless communication device 900 can be configurable or configured to transmit and receive signals and communications conforming to one or more 3GPP specifications including those for 5G NR or 6G. In some examples, the wireless communication device 900 also includes or can be coupled with one or more application processors which may be further coupled with one or more other memories. In some examples, the wireless communication device 900 further includes a user interface (UI) (such as a touchscreen or keypad) and a display, which may be integrated with the UI to form a touchscreen display that is coupled with the processing system. In some examples, the wireless communication device 900 may further include one or more sensors such as, for example, one or more inertial sensors, accelerometers, temperature sensors, pressure sensors, or altitude sensors, that are coupled with the processing system. In some examples, the wireless communication device 900 further includes at least one external network interface coupled with the processing system that enables communication with a core network or backhaul network that enables the wireless communication device 900 to gain access to external networks including the Internet.

The wireless communication device 900 includes an BSS bandwidth component 925, an auxiliary radio component 930, an expanded bandwidth communication component 935, a service period component 940, a channel sensing component 945, a NAV component 950, a puncturing component 955, an RBO component 960, and a packet detection component 965. Portions of one or more of the BSS bandwidth component 925, the auxiliary radio component 930, the expanded bandwidth communication component 935, the service period component 940, the channel sensing component 945, the NAV component 950, the puncturing component 955, the RBO component 960, and the packet detection component 965 may be implemented at least in part in hardware or firmware. For example, one or more of the BSS bandwidth component 925, the auxiliary radio component 930, the expanded bandwidth communication component 935, the service period component 940, the channel sensing component 945, the NAV component 950, the puncturing component 955, the RBO component 960, and the packet detection component 965 may be implemented at least in part by at least a processor or a modem. In some examples, portions of one or more of the BSS bandwidth component 925, the auxiliary radio component 930, the expanded bandwidth communication component 935, the service period component 940, the channel sensing component 945, the NAV component 950, the puncturing component 955, the RBO component 960, and the packet detection component 965 may be implemented at least in part by a processor and software in the form of processor-executable code stored in memory.

The wireless communication device 900 may support wireless communication in accordance with examples as disclosed herein. The BSS bandwidth component 925 is configurable or configured to establish a wireless communication link associated with a first wireless channel, where the first wireless channel is associated with a basic service set (BSS) bandwidth of the wireless communication device. The auxiliary radio component 930 is configurable or configured to monitor one or more wireless channels outside of the BSS bandwidth using one or more auxiliary radios of the wireless communication device. The expanded bandwidth communication component 935 is configurable or configured to communicate, using a main radio of the wireless communication device, via a bandwidth that includes the first wireless channel associated with the BSS bandwidth and at least one of the one or more wireless channels outside of the BSS bandwidth in accordance with monitoring the one or more wireless channels outside of the BSS bandwidth using the one or more auxiliary radios.

In some examples, to support monitoring the one or more wireless channels outside of the BSS bandwidth using the one or more auxiliary radios, the auxiliary radio component 930 is configurable or configured to monitor a primary subchannel of each wireless channel of the one or more wireless channels outside of the BSS bandwidth using a respective auxiliary radio of the one or more auxiliary radios.

In some examples, to support monitoring the primary subchannel of each wireless channel of the one or more wireless channels outside of the BSS bandwidth using the respective auxiliary radio, the auxiliary radio component 930 is configurable or configured to monitor a first primary subchannel of a second wireless channel using a first auxiliary radio of the wireless communication device. In some examples, to support monitoring the primary subchannel of each wireless channel of the one or more wireless channels outside of the BSS bandwidth using the respective auxiliary radio, the auxiliary radio component 930 is configurable or configured to monitor a second primary subchannel of a third wireless channel using a second auxiliary radio of the wireless communication device.

In some examples, to support monitoring the one or more wireless channels outside of the BSS bandwidth using the one or more auxiliary radios, the auxiliary radio component 930 is configurable or configured to monitor a primary subchannel of each wireless channel of the one or more wireless channels outside of the BSS bandwidth using a single auxiliary radio, where the one or more auxiliary radios consist of the single auxiliary radio.

In some examples, to support monitoring the primary subchannel of each wireless channel of the one or more wireless channels outside of the BSS bandwidth using the single auxiliary radio, the auxiliary radio component 930 is configurable or configured to monitor a first primary subchannel of a second wireless channel using the single auxiliary radio of the wireless communication device. In some examples, to support monitoring the primary subchannel of each wireless channel of the one or more wireless channels outside of the BSS bandwidth using the single auxiliary radio, the auxiliary radio component 930 is configurable or configured to monitor a second primary subchannel of a third wireless channel using the single auxiliary radio of the wireless communication device.

In some examples, the packet detection component 965 is configurable or configured to detect, via a first packet detector associated with the second wireless channel, a first packet on the second wireless channel as a first Wi-Fi packet, where monitoring the first primary subchannel of the second wireless channel using the single auxiliary radio is in association with detecting the first packet on the second wireless channel as the first Wi-Fi packet. In some examples, the packet detection component 965 is configurable or configured to detect, via a second packet detector associated with the third wireless channel, a second packet on the third wireless channel as a second Wi-Fi packet, where monitoring the second primary subchannel of the third wireless channel using the single auxiliary radio is in association with detecting the second packet on the third wireless channel as the second Wi-Fi packet.

In some examples, the auxiliary radio component 930 is configurable or configured to switch the single auxiliary radio from the second wireless channel to the third wireless channel in association with detecting the second packet on the third wireless channel as the second Wi-Fi packet.

In some examples, the NAV component 950 is configurable or configured to maintain a first network allocation vector counter associated with the first wireless channel associated with the BSS bandwidth of the wireless communication device. In some examples, the NAV component 950 is configurable or configured to maintain one or more network allocation vector counters associated with the one or more wireless channels outside of the BSS bandwidth in association with monitoring the one or more wireless channels using the one or more auxiliary radios, where communicating via the bandwidth that includes the first wireless channel and the at least one of the one or more wireless channels is in accordance with the first network allocation vector counter associated with the first wireless channel associated with the BSS bandwidth and the one or more network allocation vector counters associated with the one or more wireless channels outside of the BSS bandwidth.

In some examples, the NAV component 950 is configurable or configured to receive one or more packets via at least a subset of the one or more wireless channels in association with monitoring the one or more wireless channels, where each packet of the one or more packets includes information indicative of a respective duration of that packet, and where maintaining the one or more network allocation vector counters is in association with receiving the one or more packets.

In some examples, to support maintaining the one or more network allocation vector counters, the NAV component 950 is configurable or configured to maintain a first network allocation vector counter associated with a second wireless channel of the one or more wireless channels. In some examples, to support maintaining the one or more network allocation vector counters, the NAV component 950 is configurable or configured to maintain a second network allocation vector counter associated with a third wireless channel of the one or more wireless channels.

In some examples, the NAV component 950 is configurable or configured to set the first network allocation vector counter to a first value in association with receiving a first packet via the second wireless channel, where the first packet includes information indicative of a first duration of the first packet, and where the first value corresponds to the first duration. In some examples, the NAV component 950 is configurable or configured to set the second network allocation vector counter to a second value in association with receiving a second packet via the third wireless channel, where the second packet includes information indicative of a second duration of the second packet, and where the second value corresponds to the second duration.

In some examples, communicating via the bandwidth that includes the first wireless channel associated with the BSS bandwidth and the at least one of the one or more wireless channels outside of the BSS bandwidth is in accordance with the first network allocation vector counter associated with the first wireless channel associated with the BSS bandwidth being a zero value, an energy level value of the first wireless channel associated with the BSS bandwidth satisfying a first energy detection threshold value, at least one network allocation vector counter associated with the at least one of the one or more wireless channels outside of the BSS bandwidth being the zero value or not set, and at least one energy level value of the at least one of the one or more wireless channels outside of the BSS bandwidth satisfying a second energy detection threshold value.

In some examples, the RBO component 960 is configurable or configured to skip at least one random backoff process associated with the at least one of the one or more wireless channels outside of the BSS bandwidth, where communicating via the bandwidth that includes the first wireless channel associated with the BSS bandwidth and the at least one of the one or more wireless channels outside of the BSS bandwidth is in association with skipping the at least one random backoff process.

In some examples, a respective random backoff counter associated with each of the at least one of the one or more wireless channels outside of the BSS bandwidth reaches the zero value at least once prior to communicating via the bandwidth that includes the first wireless channel associated with the BSS bandwidth and the at least one of the one or more wireless channels outside of the BSS bandwidth.

In some examples, the first energy detection threshold value is different than the second energy detection threshold value.

In some examples, to support communicating via the bandwidth that includes the first wireless channel associated with the BSS bandwidth and the at least one of the one or more wireless channels outside of the BSS bandwidth, the puncturing component 955 is configurable or configured to transmit a physical layer protocol data unit (PPDU) in association with a puncturing of the PPDU, where the bandwidth excludes a wireless channel of the one or more wireless channels outside of the BSS bandwidth in accordance with the puncturing of the PPDU, and where the wireless channel is associated with a network allocation vector counter having a nonzero value or is associated with an energy level value failing to satisfy an energy detection threshold value at a transmission time.

In some examples, to support communicating via the bandwidth that includes the first wireless channel associated with the BSS bandwidth and the at least one of the one or more wireless channels outside of the BSS bandwidth, the expanded bandwidth communication component 935 is configurable or configured to communicate at least one of a request-to-send frame, a multi-user request-to-send frame, or a clear-to-send frame via the bandwidth that includes the first wireless channel associated with the BSS bandwidth and the at least one of the one or more wireless channels outside of the BSS bandwidth.

In some examples, the least one of the request-to-send frame, the multi-user request-to-send frame, or the clear-to-send frame is duplicated on each subchannel of the bandwidth that includes the first wireless channel associated with the BSS bandwidth and the at least one of the one or more wireless channels outside of the BSS bandwidth. In some examples, communicating via the bandwidth is in association with the least one of the request-to-send frame, the multi-user request-to-send frame, or the clear-to-send frame being duplicated on each subchannel of the bandwidth.

In some examples, to support communicating via the bandwidth that includes the first wireless channel associated with the BSS bandwidth and the at least one of the one or more wireless channels outside of the BSS bandwidth, the expanded bandwidth communication component 935 is configurable or configured to transmit, prior to communication of the request-to-send frame, the multi-user request-to-send frame, or the clear-to-send frame, a clear-to-send-to-self frame via the first wireless channel associated with the BSS bandwidth, where the clear-to-send-to-self frame indicates a duration associated with a time the wireless communication device expects to use to switch from the first wireless channel associated with the BSS bandwidth to an expanded bandwidth including the first wireless channel associated with the BSS bandwidth and the at least one of the one or more wireless channels outside of the BSS bandwidth, and where a transmission time of the request-to-send frame or the multi-user request-to-send frame is within the duration indicated by the clear-to-send-to-self frame.

In some examples, the expanded bandwidth communication component 935 is configurable or configured to transmit, prior to communicating via the bandwidth that includes the first wireless channel associated with the BSS bandwidth and the at least one of the one or more wireless channels outside of the BSS bandwidth, a clear-to-send-to-self frame via the first wireless channel associated with the BSS bandwidth, where the clear-to-send-to-self frame indicates a duration associated with a time the wireless communication device expects to use to switch from the first wireless channel associated with the BSS bandwidth to an expanded bandwidth including the first wireless channel associated with the BSS bandwidth and the at least one of the one or more wireless channels outside of the BSS bandwidth.

In some examples, the expanded bandwidth communication component 935 is configurable or configured to communicate information indicative of a capability of the wireless communication device to support communication via an expanded bandwidth that includes the first wireless channel associated with the BSS bandwidth and the one or more wireless channels outside of the BSS bandwidth, where monitoring the one or more wireless channels outside of the BSS bandwidth is in accordance with the capability of the wireless communication device.

In some examples, the information indicative of the capability further indicates that the wireless communication device lacks parallel packet detectors or parallel auxiliary radios. In some examples, transmission via the expanded bandwidth from the wireless communication device is restricted to trigger-based transmissions in association with the wireless communication device lacking the parallel packet detectors or the parallel auxiliary radios.

In some examples, the expanded bandwidth communication component 935 is configurable or configured to communicate a frame that includes a first field and a second field, where the first field includes an indication of the first wireless channel associated with the BSS bandwidth and the second field includes an indication of an expanded bandwidth that includes the first wireless channel associated with the BSS bandwidth and the one or more wireless channels outside of the BSS bandwidth, where monitoring the one or more wireless channels outside of the BSS bandwidth is in association with the second field indicating the expanded bandwidth.

In some examples, the expanded bandwidth communication component 935 is configurable or configured to communicate an indication of an activation or a deactivation of a mode of operation associated with the expanded bandwidth.

In some examples, the expanded bandwidth communication component 935 is configurable or configured to communicate information indicative of a set of one or more access categories associated with the expanded bandwidth, where the expanded bandwidth is restricted to being exclusively available for the set of one or more access categories.

In some examples, the first wireless channel associated with the BSS bandwidth and the one or more wireless channels outside of the BSS bandwidth are contiguous in frequency.

In some examples, the first wireless channel associated with the BSS bandwidth and the one or more wireless channels outside of the BSS bandwidth are noncontiguous in frequency.

Additionally, or alternatively, the wireless communication device 900 may support wireless communication in accordance with examples as disclosed herein. In some examples, the BSS bandwidth component 925 is configurable or configured to establish a wireless communication link associated with a first wireless channel, where the first wireless channel is associated with a basic service set (BSS) bandwidth of the wireless communication device. The service period component 940 is configurable or configured to communicate information indicative of at least one service period (such as at least one time period), where the at least one service period is associated with communication via an expanded bandwidth that includes the first wireless channel associated with the BSS bandwidth and one or more wireless channels outside of the BSS bandwidth. In some examples, the expanded bandwidth communication component 935 is configurable or configured to communicate, during a service period (such as a time period) of the at least one service period, via a bandwidth that includes the first wireless channel associated with the BSS bandwidth and at least one of the one or more wireless channels outside of the BSS bandwidth.

In some examples, to support communicating the information indicative of the at least one service period, the service period component 940 is configurable or configured to communicate information indicative of a restricted target wake time schedule associated with a set of multiple service periods, where the at least one service period includes the set of multiple service periods, and where the set of multiple service periods is protected for the communication via the expanded bandwidth.

In some examples, the service period component 940 is configurable or configured to communicate one or more frames as part of a negotiation of the restricted target wake time schedule with one or more wireless communication devices, where the one or more wireless communication devices are associated with BSS bandwidths including the one or more wireless channels outside of the BSS bandwidth of the wireless communication device.

In some examples, a first wireless communication device of the one or more wireless communication devices is associated with a first BSS bandwidth including a first wireless channel of the one or more wireless channels outside of the BSS bandwidth of the wireless communication device. In some examples, a second wireless communication device of the one or more wireless communication devices is associated with a second BSS bandwidth including a second wireless channel of the one or more wireless channels outside of the BSS bandwidth of the wireless communication device.

In some examples, to support communicating the information indicative of the at least one service period, the service period component 940 is configurable or configured to communicate a first control frame that includes an indication of the bandwidth that includes the first wireless channel associated with the BSS bandwidth and the at least one of the one or more wireless channels outside of the BSS bandwidth, where communication of the first control frame is associated with a start of the service period. In some examples, to support communicating the information indicative of the at least one service period, the service period component 940 is configurable or configured to communicate a second control frame that includes an indication of the first wireless channel associated with the BSS bandwidth, where communication of the second control frame is associated with an end of the service period.

In some examples, the first control frame is associated with a first transmission bandwidth that includes the bandwidth that includes the first wireless channel associated with the BSS bandwidth and the at least one of the one or more wireless channels outside of the BSS bandwidth. In some examples, the second control frame is associated with a second transmission bandwidth that includes the first wireless channel associated with the BSS bandwidth.

In some examples, the at least one service period consists of a single dynamic service period.

In some examples, the RBO component 960 is configurable or configured to start a random backoff counter associated with the first wireless channel at a beginning of the service period. In some examples, the channel sensing component 945 is configurable or configured to sense a primary subchannel of the first wireless channel for a time duration associated with the random backoff counter, where communicating during the service period is in accordance with the random backoff counter reaching a zero value in association with sensing the primary subchannel.

In some examples, the information indicative of the at least one service period further indicates that any wireless communication device capable of the communication via the expanded bandwidth is to sense a respective primary subchannel of a respective wireless channel associated with a respective BSS bandwidth of that wireless communication device to obtain channel access during the service period.

In some examples, the expanded bandwidth communication component 935 is configurable or configured to switching, at a beginning of the service period, a primary subchannel of the wireless communication device from a first primary subchannel of the first wireless channel to a second primary subchannel of a second wireless channel, where the one or more wireless channels outside of the BSS bandwidth include the second wireless channel. In some examples, the RBO component 960 is configurable or configured to start a random backoff counter associated with the second wireless channel in association with switching the primary subchannel of the wireless communication device from the first primary subchannel to the second primary subchannel. In some examples, the channel sensing component 945 is configurable or configured to sense the second primary subchannel of the second wireless channel for a time duration associated with the random backoff counter, where communicating during the service period is in association with sensing the second primary subchannel as idle when the random backoff counter is a zero value.

In some examples, the information indicative of the at least one service period further indicates that any wireless communication device capable of the communication via the expanded bandwidth is to sense the second primary subchannel of the second wireless channel to obtain channel access during the service period.

In some examples, to support communicating during the service period, the expanded bandwidth communication component 935 is configurable or configured to communicate at least one of a request-to-send frame, a multi-user request-to-send frame, or a clear-to-send frame via the bandwidth that includes the first wireless channel associated with the BSS bandwidth and the at least one of the one or more wireless channels outside of the BSS bandwidth.

In some examples, the least one of the request-to-send frame, the multi-user request-to-send frame, or the clear-to-send frame is duplicated on each subchannel of the bandwidth that includes the first wireless channel associated with the BSS bandwidth and the at least one of the one or more wireless channels outside of the BSS bandwidth. In some examples, communicating during the service period is in association with the least one of the request-to-send frame, the multi-user request-to-send frame, or the clear-to-send frame being duplicated on each subchannel of the bandwidth.

In some examples, to support communicating via the bandwidth that includes the first wireless channel associated with the BSS bandwidth and the at least one of the one or more wireless channels outside of the BSS bandwidth, the expanded bandwidth communication component 935 is configurable or configured to transmit, prior to communication of the request-to-send frame, the multi-user request-to-send frame, or the clear-to-send frame, a clear-to-send-to-self frame via the first wireless channel associated with the BSS bandwidth, where the clear-to-send-to-self frame indicates a duration associated with a time the wireless communication device expects to use to switch from the first wireless channel associated with the BSS bandwidth to an expanded bandwidth including the first wireless channel associated with the BSS bandwidth and the at least one of the one or more wireless channels outside of the BSS bandwidth, and where a transmission time of the request-to-send frame or the multi-user request-to-send frame is within the duration indicated by the clear-to-send-to-self frame.

In some examples, the expanded bandwidth communication component 935 is configurable or configured to transmit, prior to communicating via the bandwidth that includes the first wireless channel associated with the BSS bandwidth and the at least one of the one or more wireless channels outside of the BSS bandwidth, a clear-to-send-to-self frame via the first wireless channel associated with the BSS bandwidth, where the clear-to-send-to-self frame indicates a duration associated with a time the wireless communication device expects to use to switch from the first wireless channel associated with the BSS bandwidth to an expanded bandwidth including the first wireless channel associated with the BSS bandwidth and the at least one of the one or more wireless channels outside of the BSS bandwidth.

In some examples, the expanded bandwidth communication component 935 is configurable or configured to communicate information indicative of a capability of the wireless communication device to support communication via the expanded bandwidth that includes the first wireless channel associated with the BSS bandwidth and the one or more wireless channels outside of the BSS bandwidth, where communicating during the service period and via the bandwidth is in accordance with the capability of the wireless communication device.

In some examples, the expanded bandwidth communication component 935 is configurable or configured to communicate a frame that includes a first field and a second field, where the first field includes an indication of the first wireless channel associated with the BSS bandwidth and the second field includes an indication of an expanded bandwidth that includes the first wireless channel and the one or more wireless channels outside of the BSS bandwidth, where communicating during the service period and via the bandwidth is in accordance with the second field indicating the expanded bandwidth.

In some examples, the expanded bandwidth communication component 935 is configurable or configured to communicate an indication of an activation or a deactivation of a mode of operation associated with the expanded bandwidth.

In some examples, the expanded bandwidth communication component 935 is configurable or configured to communicate information indicative of a set of one or more access categories associated with the expanded bandwidth, where the expanded bandwidth is restricted to being exclusively available for the set of one or more access categories.

In some examples, the first wireless channel associated with the BSS bandwidth and the one or more wireless channels outside of the BSS bandwidth are contiguous in frequency.

In some examples, the first wireless channel associated with the BSS bandwidth and the one or more wireless channels outside of the BSS bandwidth are noncontiguous in frequency.

Additionally, or alternatively, the wireless communication device 900 may support wireless communication in accordance with examples as disclosed herein. In some examples, the BSS bandwidth component 925 is configurable or configured to establish a wireless communication link associated with a first wireless channel, where the first wireless channel is associated with a basic service set (BSS) bandwidth of the wireless communication device. The channel sensing component 945 is configurable or configured to sense a first primary subchannel of the first wireless channel associated with the BSS bandwidth using a first energy detection threshold value. In some examples, the channel sensing component 945 is configurable or configured to sense one or more primary subchannels of one or more wireless channels outside of the BSS bandwidth using a second energy detection threshold value, where the second energy detection threshold value is different than the first energy detection threshold value. In some examples, the expanded bandwidth communication component 935 is configurable or configured to communicate via a bandwidth that includes the first wireless channel associated with the BSS bandwidth and at least one of the one or more wireless channels outside of the BSS bandwidth in association with sensing the first primary subchannel associated with the BSS bandwidth using the first energy detection threshold value and sensing the one or more primary subchannels outside of the BSS bandwidth using the second energy detection threshold value.

In some examples, the NAV component 950 is configurable or configured to decrement a network allocation vector counter associated with the first wireless channel in association with sensing the first primary subchannel associated with the BSS bandwidth using the first energy detection threshold value and sensing the one or more primary subchannels outside of the BSS bandwidth using the second energy detection threshold value, where communicating via the bandwidth that includes the first wireless channel associated with the BSS bandwidth and the at least one of the one or more wireless channels outside of the BSS bandwidth is in association with sensing the first primary subchannel associated with the BSS bandwidth and at least one of the one or more primary subchannels outside of the BSS bandwidth as idle when the network allocation vector counter is a zero value.

In some examples, to support communicating via the bandwidth that includes the first wireless channel associated with the BSS bandwidth and the at least one of the one or more wireless channels outside of the BSS bandwidth, the puncturing component 955 is configurable or configured to transmit a physical layer protocol data unit (PPDU) in association with a puncturing of the PPDU, where the bandwidth excludes a wireless channel of the one or more wireless channels outside of the BSS bandwidth in accordance with the puncturing of the PPDU, and where the wireless channel is associated with an energy level value failing to satisfy the second energy detection threshold value at a transmission time.

In some examples, to support sensing the first primary subchannel associated with the BSS bandwidth and the one or more primary subchannels outside of the BSS bandwidth, the channel sensing component 945 is configurable or configured to sense each subchannel using a respective energy detector of the wireless communication device.

In some examples, the RBO component 960 is configurable or configured to maintain, in association with sensing the first primary subchannel associated with the BSS bandwidth and the one or more primary subchannels outside of the BSS bandwidth, a respective random backoff counter associated with each wireless channel of a set of wireless channels including the first wireless channel associated with the BSS bandwidth and the one or more wireless channels outside of the BSS bandwidth.

In some examples, random backoff counters associated with the first wireless channel associated with the BSS bandwidth and the at least one of the one or more wireless channels outside of the BSS bandwidth reaches zero at least once prior to communicating via the bandwidth that includes the first wireless channel associated with the BSS bandwidth and the at least one of the one or more wireless channels outside of the BSS bandwidth.

In some examples, to support sensing the first primary subchannel associated with the BSS bandwidth and the one or more primary subchannels outside of the BSS bandwidth, the channel sensing component 945 is configurable or configured to sense each subchannel of the first wireless channel associated with the BSS bandwidth and each subchannel of the one or more wireless channels outside of the BSS bandwidth using the first energy detection threshold value and the second energy detection threshold value, respectively, where communicating via the bandwidth that includes the first wireless channel and the at least one of the one or more wireless channels is in association with sensing each subchannel of the first wireless channel and each subchannel of the one or more wireless channels using the first energy detection threshold value and the second energy detection threshold value, respectively.

In some examples, the channel sensing component 945 is configurable or configured to sense the first primary subchannel of the first wireless channel associated with the BSS bandwidth using the first energy detection threshold value. In some examples, the BSS bandwidth component 925 is configurable or configured to communicate via a second bandwidth that includes at most the first wireless channel associated with the BSS bandwidth in association with sensing the first primary subchannel using the first energy detection threshold value.

In some examples, to support communicating via the bandwidth that includes the first wireless channel associated with the BSS bandwidth and the at least one of the one or more wireless channels outside of the BSS bandwidth, the expanded bandwidth communication component 935 is configurable or configured to communicate at least one of a request-to-send frame, a multi-user request-to-send frame, or a clear-to-send frame via the bandwidth that includes the first wireless channel associated with the BSS bandwidth and the at least one of the one or more wireless channels outside of the BSS bandwidth.

In some examples, the least one of the request-to-send frame, the multi-user request-to-send frame, or the clear-to-send frame is duplicated on each subchannel of the bandwidth that includes the first wireless channel associated with the BSS bandwidth and the at least one of the one or more wireless channels outside of the BSS bandwidth. In some examples, communicating via the bandwidth is in association with the least one of the request-to-send frame, the multi-user request-to-send frame, or the clear-to-send frame being duplicated on each subchannel of the bandwidth.

In some examples, to support communicating via the bandwidth that includes the first wireless channel associated with the BSS bandwidth and the at least one of the one or more wireless channels outside of the BSS bandwidth, the expanded bandwidth communication component 935 is configurable or configured to transmit, prior to communication of the request-to-send frame, the multi-user request-to-send frame, or the clear-to-send frame, a clear-to-send-to-self frame via the first wireless channel associated with the BSS bandwidth, where the clear-to-send-to-self frame indicates a duration associated with a time the wireless communication device expects to use to switch from the first wireless channel associated with the BSS bandwidth to an expanded bandwidth including the first wireless channel associated with the BSS bandwidth and the at least one of the one or more wireless channels outside of the BSS bandwidth, and where a transmission time of the request-to-send frame or the multi-user request-to-send frame is within the duration indicated by the clear-to-send-to-self frame.

In some examples, the expanded bandwidth communication component 935 is configurable or configured to transmit, prior to communicating via the bandwidth that includes the first wireless channel associated with the BSS bandwidth and the at least one of the one or more wireless channels outside of the BSS bandwidth, a clear-to-send-to-self frame via the first wireless channel associated with the BSS bandwidth, where the clear-to-send-to-self frame indicates a duration associated with a time the wireless communication device expects to use to switch from the first wireless channel associated with the BSS bandwidth to an expanded bandwidth including the first wireless channel associated with the BSS bandwidth and the at least one of the one or more wireless channels outside of the BSS bandwidth.

In some examples, the expanded bandwidth communication component 935 is configurable or configured to communicate information indicative of a capability of the wireless communication device to support communication via an expanded bandwidth that includes the first wireless channel associated with the BSS bandwidth and the one or more wireless channels outside of the BSS bandwidth, where sensing the first primary subchannel associated with the BSS bandwidth and the one or more primary subchannels outside of the BSS bandwidth is in accordance with the capability of the wireless communication device.

In some examples, the information indicative of the capability further indicates that the wireless communication device lacks parallel energy detectors. In some examples, transmission via the expanded bandwidth from the wireless communication device is restricted to trigger-based transmissions in association with the wireless communication device lacking the parallel energy detectors.

In some examples, the expanded bandwidth communication component 935 is configurable or configured to communicate a frame that includes a first field and a second field, where the first field includes an indication of the first wireless channel associated with the BSS bandwidth and the second field includes an indication of an expanded bandwidth that includes the first wireless channel and the one or more wireless channels outside of the BSS bandwidth, where sensing the first primary subchannel associated with the BSS bandwidth and the one or more primary subchannels outside of the BSS bandwidth is in accordance with the second field indicating the expanded bandwidth.

In some examples, the expanded bandwidth communication component 935 is configurable or configured to communicate an indication of an activation or a deactivation of a mode of operation associated with the expanded bandwidth.

In some examples, the expanded bandwidth communication component 935 is configurable or configured to communicate information indicative of a set of one or more access categories associated with the expanded bandwidth, where the expanded bandwidth is restricted to being exclusively available for the set of one or more access categories.

In some examples, the first energy detection threshold value is −72 decibel milliwatts (dBm) or −62 dBm. In some examples, the second energy detection threshold value is −82 dBm.

In some examples, the first wireless channel associated with the BSS bandwidth and the one or more wireless channels outside of the BSS bandwidth are contiguous in frequency.

In some examples, the first wireless channel associated with the BSS bandwidth and the one or more wireless channels outside of the BSS bandwidth are noncontiguous in frequency.

FIG. 10 shows a flowchart illustrating an example process 1000 performable by or at a wireless communication device that supports dynamic bandwidth expansion. The operations of the process 1000 may be implemented by a wireless communication device or its components as described herein. For example, the process 1000 may be performed by a wireless communication device, such as the wireless communication device 900 described with reference to FIG. 9, operating as or within a wireless AP or a wireless STA. In some examples, the process 1000 may be performed by a wireless AP or a wireless STA, such as one of the APs 102 or the STAs 104 described with reference to FIG. 1.

In some examples, in 1005, the wireless communication device may establish a wireless communication link associated with a first wireless channel, where the first wireless channel is associated with a BSS bandwidth of the wireless communication device. The operations of 1005 may be performed in accordance with examples as disclosed herein, such as an establishment of a wireless communication link associated with a wireless channel 304 as illustrated by and described with reference to FIGS. 3-7. Further, the establishment of the wireless communication link may occur at or in accordance with at least some of the signaling at 804 as illustrated by and described with reference to FIG. 8. In some implementations, aspects of the operations of 1005 may be performed by an BSS bandwidth component 925 as described with reference to FIG. 9.

In some examples, in 1010, the wireless communication device may monitor one or more wireless channels outside of the BSS bandwidth using one or more auxiliary radios of the wireless communication device. The operations of 1010 may be performed in accordance with examples as disclosed herein, such as via or in accordance with one or more auxiliary radios 402-a, one or more auxiliary radios 402-b, one or more auxiliary radios 402-c, or one or more auxiliary radios 402-d of FIG. 4, and/or via or in accordance with one or more packet detectors 404-a, one or more packet detectors 404-b, one or more packet detectors 404-c, or one or more packet detectors 404-d of FIG. 4. The monitoring may be associated with a criteria associated with expanded bandwidth communication, which may be satisfied at 806 as illustrated by and described with reference to FIG. 8. In some implementations, aspects of the operations of 1010 may be performed by an auxiliary radio component 930 as described with reference to FIG. 9.

In some examples, in 1015, the wireless communication device may communicate, using a main radio of the wireless communication device, via a bandwidth that includes the first wireless channel associated with the BSS bandwidth and at least one of the one or more wireless channels outside of the BSS bandwidth in accordance with monitoring the one or more wireless channels outside of the BSS bandwidth using the one or more auxiliary radios. The operations of 1015 may be performed in accordance with examples as disclosed herein, such as the communication 410-a or the communication 410-b of FIG. 4. In some implementations, aspects of the operations of 1015 may be performed by an expanded bandwidth communication component 935 as described with reference to FIG. 9.

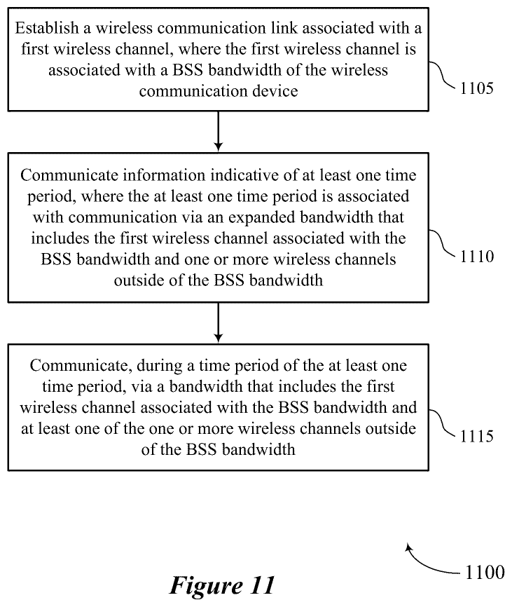

FIG. 11 shows a flowchart illustrating an example process 1100 performable by or at a wireless communication device that supports dynamic bandwidth expansion. The operations of the process 1100 may be implemented by a wireless communication device or its components as described herein. For example, the process 1100 may be performed by a wireless communication device, such as the wireless communication device 900 described with reference to FIG. 9, operating as or within a wireless AP or a wireless STA. In some examples, the process 1100 may be performed by a wireless AP or a wireless STA, such as one of the APs 102 or the STAs 104 described with reference to FIG. 1.

In some examples, in 1105, the wireless communication device may establish a wireless communication link associated with a first wireless channel, where the first wireless channel is associated with a BSS bandwidth of the wireless communication device. The operations of 1105 may be performed in accordance with examples as disclosed herein, such as an establishment of a wireless communication link associated with a wireless channel 304 as illustrated by and described with reference to FIGS. 3-7. Further, the establishment of the wireless communication link may occur at or in accordance with at least some of the signaling at 804 as illustrated by and described with reference to FIG. 8. In some implementations, aspects of the operations of 1105 may be performed by an BSS bandwidth component 925 as described with reference to FIG. 9.

In some examples, in 1110, the wireless communication device may communicate information indicative of at least one time period, where the at least one time period is associated with communication via an expanded bandwidth that includes the first wireless channel associated with the BSS bandwidth and one or more wireless channels outside of the BSS bandwidth. The operations of 1110 may be performed in accordance with examples as disclosed herein, such as the r-TWT service period 502 of FIG. 5, the r-TWT service period 602 of FIG. 6, or the dynamic service period 702 of FIG. 7. Such information may be conveyed via at least some signaling at 804 as illustrated by and described with reference to FIG. 8. In some implementations, aspects of the operations of 1110 may be performed by a service period component 940 as described with reference to FIG. 9.

In some examples, in 1115, the wireless communication device may communicate, during a time period of the at least one time period, via a bandwidth that includes the first wireless channel associated with the BSS bandwidth and at least one of the one or more wireless channels outside of the BSS bandwidth. The operations of 1115 may be performed in accordance with examples as disclosed herein, such as the communication 508-a or the communication 508-b of FIG. 5, the communication 608-a or the communication 608-b of FIG. 6, or the communication 708 of FIG. 7. In some implementations, aspects of the operations of 1115 may be performed by an expanded bandwidth communication component 935 as described with reference to FIG. 9.

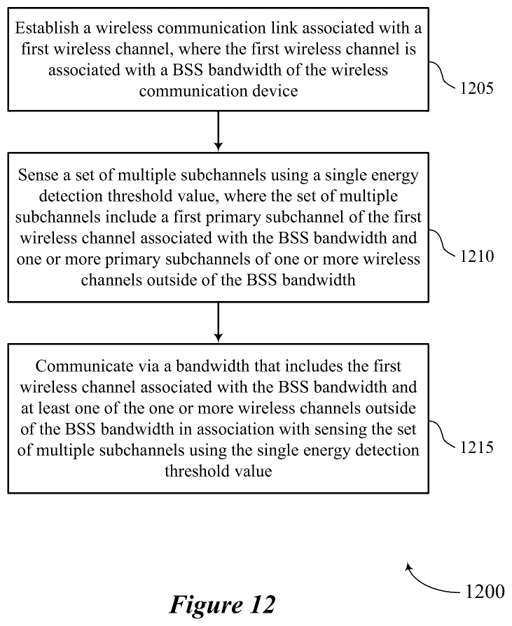

FIG. 12 shows a flowchart illustrating an example process 1200 performable by or at a wireless communication device that supports dynamic bandwidth expansion. The operations of the process 1200 may be implemented by a wireless communication device or its components as described herein. For example, the process 1200 may be performed by a wireless communication device, such as the wireless communication device 900 described with reference to FIG. 9, operating as or within a wireless AP or a wireless STA. In some examples, the process 1200 may be performed by a wireless AP or a wireless STA, such as one of the APs 102 or the STAs 104 described with reference to FIG. 1.

In some examples, in 1205, the wireless communication device may establish a wireless communication link associated with a first wireless channel, where the first wireless channel is associated with a BSS bandwidth of the wireless communication device. The operations of 1205 may be performed in accordance with examples as disclosed herein, such as an establishment of a wireless communication link associated with a wireless channel 304 as illustrated by and described with reference to FIGS. 3-7. Further, the establishment of the wireless communication link may occur at or in accordance with at least some of the signaling at 804 as illustrated by and described with reference to FIG. 8. In some implementations, aspects of the operations of 1205 may be performed by an BSS bandwidth component 925 as described with reference to FIG. 9.

In some examples, in 1210, the wireless communication device may sense a set of multiple subchannels using a single energy detection threshold value, where the set of multiple subchannels include a first primary subchannel of the first wireless channel associated with the BSS bandwidth and one or more primary subchannels of one or more wireless channels outside of the BSS bandwidth. The operations of 1210 may be performed in accordance with examples as disclosed herein, such as the single energy detection threshold value as described with reference to FIG. 4. In some aspects, an indication of the single energy detection threshold value may be communicated via at least some signaling at 804 as illustrated by and described with reference to FIG. 8. In some implementations, aspects of the operations of 1210 may be performed by a channel sensing component 945 as described with reference to FIG. 9.

In some examples, in 1215, the wireless communication device may communicate via a bandwidth that includes the first wireless channel associated with the BSS bandwidth and at least one of the one or more wireless channels outside of the BSS bandwidth in association with sensing the set of multiple subchannels using the single energy detection threshold value. The operations of 1215 may be performed in accordance with examples as disclosed herein, such as the communication 410-a or the communication 410-b of FIG. 4. In some implementations, aspects of the operations of 1215 may be performed by an expanded bandwidth communication component 935 as described with reference to FIG. 9.

Implementation examples are described in the following numbered clauses:

Clause 1: A method for wireless communication by a wireless communication device, including: establishing a wireless communication link associated with a first wireless channel, where the first wireless channel is associated with a BSS bandwidth of the wireless communication device; monitoring one or more wireless channels outside of the BSS bandwidth using one or more auxiliary radios of the wireless communication device; and communicating, using a main radio of the wireless communication device, via a bandwidth that includes the first wireless channel associated with the BSS bandwidth and at least one of the one or more wireless channels outside of the BSS bandwidth in accordance with monitoring the one or more wireless channels outside of the BSS bandwidth using the one or more auxiliary radios.

Clause 2: The method of clause 1, where monitoring the one or more wireless channels outside of the BSS bandwidth using the one or more auxiliary radios includes: monitoring a primary subchannel of each wireless channel of the one or more wireless channels outside of the BSS bandwidth using a respective auxiliary radio of the one or more auxiliary radios.

Clause 3: The method of clause 2, where monitoring the primary subchannel of each wireless channel of the one or more wireless channels outside of the BSS bandwidth using the respective auxiliary radio includes: monitoring a first primary subchannel of a second wireless channel using a first auxiliary radio of the wireless communication device; and monitoring a second primary subchannel of a third wireless channel using a second auxiliary radio of the wireless communication device.

Clause 4: The method of clause 1, where monitoring the one or more wireless channels outside of the BSS bandwidth using the one or more auxiliary radios includes: monitoring a primary subchannel of each wireless channel of the one or more wireless channels outside of the BSS bandwidth using a single auxiliary radio, where the one or more auxiliary radios consist of the single auxiliary radio.

Clause 5: The method of clause 4, where monitoring the primary subchannel of each wireless channel of the one or more wireless channels outside of the BSS bandwidth using the single auxiliary radio includes: monitoring a first primary subchannel of a second wireless channel using the single auxiliary radio of the wireless communication device; and monitoring a second primary subchannel of a third wireless channel using the single auxiliary radio of the wireless communication device.

Clause 6: The method of clause 5, further including: detecting, via a first packet detector associated with the second wireless channel, a first packet on the second wireless channel as a first Wi-Fi packet, where monitoring the first primary subchannel of the second wireless channel using the single auxiliary radio is in association with detecting the first packet on the second wireless channel as the first Wi-Fi packet; and detecting, via a second packet detector associated with the third wireless channel, a second packet on the third wireless channel as a second Wi-Fi packet, where monitoring the second primary subchannel of the third wireless channel using the single auxiliary radio is in association with detecting the second packet on the third wireless channel as the second Wi-Fi packet.

Clause 7: The method of clause 6, further including: switching the single auxiliary radio from the second wireless channel to the third wireless channel in association with detecting the second packet on the third wireless channel as the second Wi-Fi packet.

Clause 8: The method of any of clauses 1-7, further including: maintaining a first network allocation vector counter associated with the first wireless channel associated with the BSS bandwidth of the wireless communication device; and maintaining one or more network allocation vector counters associated with the one or more wireless channels outside of the BSS bandwidth in association with monitoring the one or more wireless channels using the one or more auxiliary radios, where communicating via the bandwidth that includes the first wireless channel and the at least one of the one or more wireless channels is in accordance with the first network allocation vector counter associated with the first wireless channel associated with the BSS bandwidth and the one or more network allocation vector counters associated with the one or more wireless channels outside of the BSS bandwidth.

Clause 9: The method of clause 8, further including: receiving one or more packets via at least a subset of the one or more wireless channels in association with monitoring the one or more wireless channels, where each packet of the one or more packets includes information indicative of a respective duration of that packet, and where maintaining the one or more network allocation vector counters is in association with receiving the one or more packets.

Clause 10: The method of any of clauses 8-9, where maintaining the one or more network allocation vector counters includes: maintaining a first network allocation vector counter associated with a second wireless channel of the one or more wireless channels; and maintaining a second network allocation vector counter associated with a third wireless channel of the one or more wireless channels.

Clause 11: The method of clause 10, further including: setting the first network allocation vector counter to a first value in association with receiving a first packet via the second wireless channel, where the first packet includes information indicative of a first duration of the first packet, and where the first value corresponds to the first duration; and setting the second network allocation vector counter to a second value in association with receiving a second packet via the third wireless channel, where the second packet includes information indicative of a second duration of the second packet, and where the second value corresponds to the second duration.

Clause 12: The method of any of clauses 8-11, where communicating via the bandwidth that includes the first wireless channel associated with the BSS bandwidth and the at least one of the one or more wireless channels outside of the BSS bandwidth is in accordance with the first network allocation vector counter associated with the first wireless channel associated with the BSS bandwidth being a zero value, an energy level value of the first wireless channel associated with the BSS bandwidth satisfying a first energy detection threshold value, at least one network allocation vector counter associated with the at least one of the one or more wireless channels outside of the BSS bandwidth being the zero value or not set, and at least one energy level value of the at least one of the one or more wireless channels outside of the BSS bandwidth satisfying a second energy detection threshold value.

Clause 13: The method of clause 12, further including: skipping at least one random backoff process associated with the at least one of the one or more wireless channels outside of the BSS bandwidth, where communicating via the bandwidth that includes the first wireless channel associated with the BSS bandwidth and the at least one of the one or more wireless channels outside of the BSS bandwidth is in association with skipping the at least one random backoff process.

Clause 14: The method of clause 12, where a respective random backoff counter associated with each of the at least one of the one or more wireless channels outside of the BSS bandwidth reaches the zero value at least once prior to communicating via the bandwidth that includes the first wireless channel associated with the BSS bandwidth and the at least one of the one or more wireless channels outside of the BSS bandwidth.

Clause 15: The method of any of clauses 12-14, where the first energy detection threshold value is different than the second energy detection threshold value.

Clause 16: The method of any of clauses 1-15, where communicating via the bandwidth that includes the first wireless channel associated with the BSS bandwidth and the at least one of the one or more wireless channels outside of the BSS bandwidth includes: transmitting a PPDU in association with a puncturing of the PPDU, where the bandwidth excludes a wireless channel of the one or more wireless channels outside of the BSS bandwidth in accordance with the puncturing of the PPDU, and where the wireless channel is associated with a network allocation vector counter having a nonzero value or is associated with an energy level value failing to satisfy an energy detection threshold value at a transmission time.

Clause 17: The method of any of clauses 1-16, where communicating via the bandwidth that includes the first wireless channel associated with the BSS bandwidth and the at least one of the one or more wireless channels outside of the BSS bandwidth includes: communicating at least one of a request-to-send frame, a multi-user request-to-send frame, or a clear-to-send frame via the bandwidth that includes the first wireless channel associated with the BSS bandwidth and the at least one of the one or more wireless channels outside of the BSS bandwidth.

Clause 18: The method of clause 17, where the least one of the request-to-send frame, the multi-user request-to-send frame, or the clear-to-send frame is duplicated on each subchannel of the bandwidth that includes the first wireless channel associated with the BSS bandwidth and the at least one of the one or more wireless channels outside of the BSS bandwidth, communicating via the bandwidth is in association with the least one of the request-to-send frame, the multi-user request-to-send frame, or the clear-to-send frame being duplicated on each subchannel of the bandwidth.

Clause 19: The method of any of clauses 17-18, where communicating via the bandwidth that includes the first wireless channel associated with the BSS bandwidth and the at least one of the one or more wireless channels outside of the BSS bandwidth includes: transmitting, prior to communication of the request-to-send frame, the multi-user request-to-send frame, or the clear-to-send frame, a clear-to-send-to-self frame via the first wireless channel associated with the BSS bandwidth, where the clear-to-send-to-self frame indicates a duration associated with a time the wireless communication device expects to use to switch from the first wireless channel associated with the BSS bandwidth to an expanded bandwidth including the first wireless channel associated with the BSS bandwidth and the at least one of the one or more wireless channels outside of the BSS bandwidth, and where a transmission time of the request-to-send frame or the multi-user request-to-send frame is within the duration indicated by the clear-to-send-to-self frame.

Clause 20: The method of any of clauses 1-19, further including: transmitting, prior to communicating via the bandwidth that includes the first wireless channel associated with the BSS bandwidth and the at least one of the one or more wireless channels outside of the BSS bandwidth, a clear-to-send-to-self frame via the first wireless channel associated with the BSS bandwidth, where the clear-to-send-to-self frame indicates a duration associated with a time the wireless communication device expects to use to switch from the first wireless channel associated with the BSS bandwidth to an expanded bandwidth including the first wireless channel associated with the BSS bandwidth and the at least one of the one or more wireless channels outside of the BSS bandwidth.

Clause 21: The method of any of clauses 1-20, further including: communicating information indicative of a capability of the wireless communication device to support communication via an expanded bandwidth that includes the first wireless channel associated with the BSS bandwidth and the one or more wireless channels outside of the BSS bandwidth, where monitoring the one or more wireless channels outside of the BSS bandwidth is in accordance with the capability of the wireless communication device.

Clause 22: The method of clause 21, where the information indicative of the capability further indicates that the wireless communication device lacks parallel packet detectors or parallel auxiliary radios, and transmission via the expanded bandwidth from the wireless communication device is restricted to trigger-based transmissions in association with the wireless communication device lacking the parallel packet detectors or the parallel auxiliary radios.

Clause 23: The method of any of clauses 1-22, further including: communicating a frame that includes a first field and a second field, where the first field includes an indication of the first wireless channel associated with the BSS bandwidth and the second field includes an indication of an expanded bandwidth that includes the first wireless channel associated with the BSS bandwidth and the one or more wireless channels outside of the BSS bandwidth, where monitoring the one or more wireless channels outside of the BSS bandwidth is in association with the second field indicating the expanded bandwidth.

Clause 24: The method of clause 23, further including: communicating an indication of an activation or a deactivation of a mode of operation associated with the expanded bandwidth.

Clause 25: The method of any of clauses 23-24, further including: communicating information indicative of a set of one or more access categories associated with the expanded bandwidth, where the expanded bandwidth is restricted to being exclusively available for the set of one or more access categories.

Clause 26: The method of any of clauses 1-25, where the first wireless channel associated with the BSS bandwidth and the one or more wireless channels outside of the BSS bandwidth are contiguous in frequency.

Clause 27: The method of any of clauses 1-25, where the first wireless channel associated with the BSS bandwidth and the one or more wireless channels outside of the BSS bandwidth are noncontiguous in frequency.

Clause 28: A method for wireless communication by a wireless communication device, including: establishing a wireless communication link associated with a first wireless channel, where the first wireless channel is associated with a BSS bandwidth of the wireless communication device; communicating information indicative of at least one service period (such as at least one time period), where the at least one service period is associated with communication via an expanded bandwidth that includes the first wireless channel associated with the BSS bandwidth and one or more wireless channels outside of the BSS bandwidth; and communicating, during a service period (such as a time period) of the at least one service period, via a bandwidth that includes the first wireless channel associated with the BSS bandwidth and at least one of the one or more wireless channels outside of the BSS bandwidth.

Clause 29: The method of clause 28, where communicating the information indicative of the at least one service period includes: communicating information indicative of a restricted target wake time schedule associated with a plurality of service periods, where the at least one service period includes the plurality of service periods, and where the plurality of service periods is protected for the communication via the expanded bandwidth.

Clause 30: The method of clause 29, further including: communicating one or more frames as part of a negotiation of the restricted target wake time schedule with one or more wireless communication devices, where the one or more wireless communication devices are associated with BSS bandwidths including the one or more wireless channels outside of the BSS bandwidth of the wireless communication device.

Clause 31: The method of clause 30, where a first wireless communication device of the one or more wireless communication devices is associated with a first BSS bandwidth including a first wireless channel of the one or more wireless channels outside of the BSS bandwidth of the wireless communication device, and a second wireless communication device of the one or more wireless communication devices is associated with a second BSS bandwidth including a second wireless channel of the one or more wireless channels outside of the BSS bandwidth of the wireless communication device.

Clause 32: The method of clause 28, where communicating the information indicative of the at least one service period includes: communicating a first control frame that includes an indication of the bandwidth that includes the first wireless channel associated with the BSS bandwidth and the at least one of the one or more wireless channels outside of the BSS bandwidth, where communication of the first control frame is associated with a start of the service period; and communicating a second control frame that includes an indication of the first wireless channel associated with the BSS bandwidth, where communication of the second control frame is associated with an end of the service period.

Clause 33: The method of clause 32, where the first control frame is associated with a first transmission bandwidth that includes the bandwidth that includes the first wireless channel associated with the BSS bandwidth and the at least one of the one or more wireless channels outside of the BSS bandwidth, and the second control frame is associated with a second transmission bandwidth that includes the first wireless channel associated with the BSS bandwidth.

Clause 34: The method of any of clauses 32-33, where the at least one service period consists of a single dynamic service period.

Clause 35: The method of any of clauses 28-34, further including: starting a random backoff counter associated with the first wireless channel at a beginning of the service period; and sensing a primary subchannel of the first wireless channel for a time duration associated with the random backoff counter, where communicating during the service period is in accordance with the random backoff counter reaching a zero value in association with sensing the primary subchannel.

Clause 36: The method of clause 35, where the information indicative of the at least one service period further indicates that any wireless communication device capable of the communication via the expanded bandwidth is to sense a respective primary subchannel of a respective wireless channel associated with a respective BSS bandwidth of that wireless communication device to obtain channel access during the service period.

Clause 37: The method of any of clauses 28-34, further including: switching, at a beginning of the service period, a primary subchannel of the wireless communication device from a first primary subchannel of the first wireless channel to a second primary subchannel of a second wireless channel, where the one or more wireless channels outside of the BSS bandwidth include the second wireless channel; starting a random backoff counter associated with the second wireless channel in association with switching the primary subchannel of the wireless communication device from the first primary subchannel to the second primary subchannel; and sensing the second primary subchannel of the second wireless channel for a time duration associated with the random backoff counter, where communicating during the service period is in association with sensing the second primary subchannel as idle when the random backoff counter is a zero value.

Clause 38: The method of clause 37, where the information indicative of the at least one service period further indicates that any wireless communication device capable of the communication via the expanded bandwidth is to sense the second primary subchannel of the second wireless channel to obtain channel access during the service period.

Clause 39: The method of any of clauses 28-38, where communicating during the service period includes: communicating at least one of a request-to-send frame, a multi-user request-to-send frame, or a clear-to-send frame via the bandwidth that includes the first wireless channel associated with the BSS bandwidth and the at least one of the one or more wireless channels outside of the BSS bandwidth.

Clause 40: The method of clause 39, where the least one of the request-to-send frame, the multi-user request-to-send frame, or the clear-to-send frame is duplicated on each subchannel of the bandwidth that includes the first wireless channel associated with the BSS bandwidth and the at least one of the one or more wireless channels outside of the BSS bandwidth, communicating during the service period is in association with the least one of the request-to-send frame, the multi-user request-to-send frame, or the clear-to-send frame being duplicated on each subchannel of the bandwidth.

Clause 41: The method of any of clauses 39-40, where communicating via the bandwidth that includes the first wireless channel associated with the BSS bandwidth and the at least one of the one or more wireless channels outside of the BSS bandwidth includes: transmitting, prior to communication of the request-to-send frame, the multi-user request-to-send frame, or the clear-to-send frame, a clear-to-send-to-self frame via the first wireless channel associated with the BSS bandwidth, where the clear-to-send-to-self frame indicates a duration associated with a time the wireless communication device expects to use to switch from the first wireless channel associated with the BSS bandwidth to an expanded bandwidth including the first wireless channel associated with the BSS bandwidth and the at least one of the one or more wireless channels outside of the BSS bandwidth, and where a transmission time of the request-to-send frame or the multi-user request-to-send frame is within the duration indicated by the clear-to-send-to-self frame.

Clause 42: The method of any of clauses 28-41, further including: transmitting, prior to communicating via the bandwidth that includes the first wireless channel associated with the BSS bandwidth and the at least one of the one or more wireless channels outside of the BSS bandwidth, a clear-to-send-to-self frame via the first wireless channel associated with the BSS bandwidth, where the clear-to-send-to-self frame indicates a duration associated with a time the wireless communication device expects to use to switch from the first wireless channel associated with the BSS bandwidth to an expanded bandwidth including the first wireless channel associated with the BSS bandwidth and the at least one of the one or more wireless channels outside of the BSS bandwidth.

Clause 43: The method of any of clauses 28-42, further including: communicating information indicative of a capability of the wireless communication device to support communication via the expanded bandwidth that includes the first wireless channel associated with the BSS bandwidth and the one or more wireless channels outside of the BSS bandwidth, where communicating during the service period and via the bandwidth is in accordance with the capability of the wireless communication device.

Clause 44: The method of any of clauses 28-43, further including: communicating a frame that includes a first field and a second field, where the first field includes an indication of the first wireless channel associated with the BSS bandwidth and the second field includes an indication of an expanded bandwidth that includes the first wireless channel and the one or more wireless channels outside of the BSS bandwidth, where communicating during the service period and via the bandwidth is in accordance with the second field indicating the expanded bandwidth.

Clause 45: The method of clause 44, further including: communicating an indication of an activation or a deactivation of a mode of operation associated with the expanded bandwidth.

Clause 46: The method of any of clauses 44-45, further including: communicating information indicative of a set of one or more access categories associated with the expanded bandwidth, where the expanded bandwidth is restricted to being exclusively available for the set of one or more access categories.

Clause 47: The method of any of clauses 28-46, where the first wireless channel associated with the BSS bandwidth and the one or more wireless channels outside of the BSS bandwidth are contiguous in frequency.

Clause 48: The method of any of clauses 28-46, where the first wireless channel associated with the BSS bandwidth and the one or more wireless channels outside of the BSS bandwidth are noncontiguous in frequency.

Clause 49: A method for wireless communication by a wireless communication device, including: establishing a wireless communication link associated with a first wireless channel, where the first wireless channel is associated with a BSS bandwidth of the wireless communication device; sensing a first primary subchannel of the first wireless channel associated with the BSS bandwidth using a first energy detection threshold value; sensing one or more primary subchannels of one or more wireless channels outside of the BSS bandwidth using a second energy detection threshold value, where the second energy detection threshold value is different than the first energy detection threshold value; and communicating via a bandwidth that includes the first wireless channel associated with the BSS bandwidth and at least one of the one or more wireless channels outside of the BSS bandwidth in association with sensing the first primary subchannel associated with the BSS bandwidth using the first energy detection threshold value and sensing the one or more primary subchannels outside of the BSS bandwidth using the second energy detection threshold value.

Clause 50: The method of clause 49, further including: decrementing a network allocation vector counter associated with the first wireless channel in association with sensing the first primary subchannel associated with the BSS bandwidth using the first energy detection threshold value and sensing the one or more primary subchannels outside of the BSS bandwidth using the second energy detection threshold value, where communicating via the bandwidth that includes the first wireless channel associated with the BSS bandwidth and the at least one of the one or more wireless channels outside of the BSS bandwidth is in association with sensing the first primary subchannel associated with the BSS bandwidth and at least one of the one or more primary subchannels outside of the BSS bandwidth as idle when the network allocation vector counter is a zero value.

Clause 51: The method of any of clauses 49-50, where communicating via the bandwidth that includes the first wireless channel associated with the BSS bandwidth and the at least one of the one or more wireless channels outside of the BSS bandwidth includes: transmitting a PPDU in association with a puncturing of the PPDU, where the bandwidth excludes a wireless channel of the one or more wireless channels outside of the BSS bandwidth in accordance with the puncturing of the PPDU, and where the wireless channel is associated with an energy level value failing to satisfy the second energy detection threshold value at a transmission time.

Clause 52: The method of any of clauses 49-51, where sensing the first primary subchannel associated with the BSS bandwidth and the one or more primary subchannels outside of the BSS bandwidth includes: sensing each subchannel using a respective energy detector of the wireless communication device.

Clause 53: The method of any of clauses 49-52, further including: maintaining, in association with sensing the first primary subchannel associated with the BSS bandwidth and the one or more primary subchannels outside of the BSS bandwidth, a respective random backoff counter associated with each wireless channel of a set of wireless channels including the first wireless channel associated with the BSS bandwidth and the one or more wireless channels outside of the BSS bandwidth.

Clause 54: The method of clause 53, where random backoff counters associated with the first wireless channel associated with the BSS bandwidth and the at least one of the one or more wireless channels outside of the BSS bandwidth reach zero at least once prior to communicating via the bandwidth that includes the first wireless channel associated with the BSS bandwidth and the at least one of the one or more wireless channels outside of the BSS bandwidth.

Clause 55: The method of any of clauses 49-54, where sensing the first primary subchannel associated with the BSS bandwidth and the one or more primary subchannels outside of the BSS bandwidth includes: sensing each subchannel of the first wireless channel associated with the BSS bandwidth and each subchannel of the one or more wireless channels outside of the BSS bandwidth using the first energy detection threshold value and the second energy detection threshold value, respectively, where communicating via the bandwidth that includes the first wireless channel and the at least one of the one or more wireless channels is in association with sensing each subchannel of the first wireless channel and each subchannel of the one or more wireless channels using the first energy detection threshold value and the second energy detection threshold value, respectively.

Clause 56: The method of any of clauses 49-55, further including: sensing the first primary subchannel of the first wireless channel associated with the BSS bandwidth using the first energy detection threshold value; and communicating via a second bandwidth that includes at most the first wireless channel associated with the BSS bandwidth in association with sensing the first primary subchannel using the first energy detection threshold value.

Clause 57: The method of any of clauses 49-56, where communicating via the bandwidth that includes the first wireless channel associated with the BSS bandwidth and the at least one of the one or more wireless channels outside of the BSS bandwidth includes: communicating at least one of a request-to-send frame, a multi-user request-to-send frame, or a clear-to-send frame via the bandwidth that includes the first wireless channel associated with the BSS bandwidth and the at least one of the one or more wireless channels outside of the BSS bandwidth.

Clause 58: The method of clause 57, where the least one of the request-to-send frame, the multi-user request-to-send frame, or the clear-to-send frame is duplicated on each subchannel of the bandwidth that includes the first wireless channel associated with the BSS bandwidth and the at least one of the one or more wireless channels outside of the BSS bandwidth, communicating via the bandwidth is in association with the least one of the request-to-send frame, the multi-user request-to-send frame, or the clear-to-send frame being duplicated on each subchannel of the bandwidth.

Clause 59: The method of any of clauses 57-58, where communicating via the bandwidth that includes the first wireless channel associated with the BSS bandwidth and the at least one of the one or more wireless channels outside of the BSS bandwidth includes: transmitting, prior to communication of the request-to-send frame, the multi-user request-to-send frame, or the clear-to-send frame, a clear-to-send-to-self frame via the first wireless channel associated with the BSS bandwidth, where the clear-to-send-to-self frame indicates a duration associated with a time the wireless communication device expects to use to switch from the first wireless channel associated with the BSS bandwidth to an expanded bandwidth including the first wireless channel associated with the BSS bandwidth and the at least one of the one or more wireless channels outside of the BSS bandwidth, and where a transmission time of the request-to-send frame or the multi-user request-to-send frame is within the duration indicated by the clear-to-send-to-self frame.

Clause 60: The method of any of clauses 49-59, further including: transmitting, prior to communicating via the bandwidth that includes the first wireless channel associated with the BSS bandwidth and the at least one of the one or more wireless channels outside of the BSS bandwidth, a clear-to-send-to-self frame via the first wireless channel associated with the BSS bandwidth, where the clear-to-send-to-self frame indicates a duration associated with a time the wireless communication device expects to use to switch from the first wireless channel associated with the BSS bandwidth to an expanded bandwidth including the first wireless channel associated with the BSS bandwidth and the at least one of the one or more wireless channels outside of the BSS bandwidth.

Clause 61: The method of any of clauses 49-60, further including: communicating information indicative of a capability of the wireless communication device to support communication via an expanded bandwidth that includes the first wireless channel associated with the BSS bandwidth and the one or more wireless channels outside of the BSS bandwidth, where sensing the first primary subchannel associated with the BSS bandwidth and the one or more primary subchannels outside of the BSS bandwidth is in accordance with the capability of the wireless communication device.

Clause 62: The method of clause 61, where the information indicative of the capability further indicates that the wireless communication device lacks parallel energy detectors, and transmission via the expanded bandwidth from the wireless communication device is restricted to trigger-based transmissions in association with the wireless communication device lacking the parallel energy detectors.

Clause 63: The method of any of clauses 49-62, further including: communicating a frame that includes a first field and a second field, where the first field includes an indication of the first wireless channel associated with the BSS bandwidth and the second field includes an indication of an expanded bandwidth that includes the first wireless channel and the one or more wireless channels outside of the BSS bandwidth, where sensing the first primary subchannel associated with the BSS bandwidth and the one or more primary subchannels outside of the BSS bandwidth is in accordance with the second field indicating the expanded bandwidth.

Clause 64: The method of clause 63, further including: communicating an indication of an activation or a deactivation of a mode of operation associated with the expanded bandwidth.

Clause 65: The method of any of clauses 63-64, further including: communicating information indicative of a set of one or more access categories associated with the expanded bandwidth, where the expanded bandwidth is restricted to being exclusively available for the set of one or more access categories.

Clause 66: The method of any of clauses 49-65, where the first energy detection threshold value is-72 dBm or −62 dBm, and the second energy detection threshold value is-82 dBm.

Clause 67: The method of any of clauses 49-66, where the first wireless channel associated with the BSS bandwidth and the one or more wireless channels outside of the BSS bandwidth are contiguous in frequency.

Clause 68: The method of any of clauses 49-66, where the first wireless channel associated with the BSS bandwidth and the one or more wireless channels outside of the BSS bandwidth are noncontiguous in frequency.

Clause 69: A wireless communication device, including a processing system that includes processor circuitry and memory circuitry that stores code, the processing system configured to cause the wireless communication device to perform a method of any of clauses 1-27.

Clause 70: A wireless communication device, including at least one means for performing a method of any of clauses 1-27.

Clause 71: A non-transitory computer-readable medium storing code for wireless communication, the code including instructions executable by a processing system (such as one or more processors) to perform a method of any of clauses 1-27.

Clause 72: A wireless communication device, including a processing system that includes processor circuitry and memory circuitry that stores code, the processing system configured to cause the wireless communication device to perform a method of any of clauses 28-48.

Clause 73: A wireless communication device, including at least one means for performing a method of any of clauses 28-48.

Clause 74: A non-transitory computer-readable medium storing code for wireless communication, the code including instructions executable by a processing system (such as one or more processors) to perform a method of any of clauses 28-48.

Clause 75: A wireless communication device, including a processing system that includes processor circuitry and memory circuitry that stores code, the processing system configured to cause the wireless communication device to perform a method of any of clauses 49-68.

Clause 76: A wireless communication device, including at least one means for performing a method of any of clauses 49-68.

Clause 77: A non-transitory computer-readable medium storing code for wireless communication, the code including instructions executable by a processing system (such as one or more processors) to perform a method of any of clauses 49-68.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless communication device, comprising:
a processing system that includes processor circuitry and memory circuitry that stores code, the processing system configured to cause the wireless communication device to:
establish a wireless communication link associated with a first wireless channel, wherein the first wireless channel is associated with a basic service set (BSS) bandwidth of the wireless communication device;
communicate information indicative of at least one time period, wherein the at least one time period is associated with communication via an expanded bandwidth that includes the first wireless channel associated with the BSS bandwidth and one or more wireless channels outside of the BSS bandwidth; and
communicate, during a time period of the at least one time period, via a bandwidth that includes the first wireless channel associated with the BSS bandwidth and at least one of the one or more wireless channels outside of the BSS bandwidth.

2. The wireless communication device of claim 1, wherein the processing system is further configured to cause the wireless communication device to:
communicate an indication of an activation or a deactivation of a mode of operation associated with the expanded bandwidth.

3. The wireless communication device of claim 2, wherein the indication of the activation or the deactivation of the mode of operation associated with the expanded bandwidth is comprised within a management frame.

4. The wireless communication device of claim 1, wherein the processing system is further configured to cause the wireless communication device to:
communicate a frame that includes a first field and a second field, wherein the first field includes an indication of the first wireless channel associated with the BSS bandwidth and the second field includes an indication of the expanded bandwidth that includes the first wireless channel and the one or more wireless channels outside of the BSS bandwidth, wherein communicating during the time period and via the bandwidth is in accordance with the second field indicating the expanded bandwidth.

5. The wireless communication device of claim 1, wherein the processing system is further configured to cause the wireless communication device to:
communicate information indicative of a set of one or more access categories associated with the expanded bandwidth, wherein the expanded bandwidth is restricted to being exclusively available for the set of one or more access categories.

6. The wireless communication device of claim 1, wherein, to communicate the information indicative of the at least one time period, the processing system is configured to cause the wireless communication device to:
communicate information indicative of a restricted target wake time schedule associated with a plurality of service periods, wherein the at least one time period includes the plurality of service periods, and wherein the plurality of service periods is protected for the communication via the expanded bandwidth.

7. The wireless communication device of claim 6, wherein the processing system is further configured to cause the wireless communication device to:
communicate one or more frames as part of a negotiation of the restricted target wake time schedule with one or more wireless communication devices, wherein the one or more wireless communication devices are associated with BSS bandwidths including the one or more wireless channels outside of the BSS bandwidth of the wireless communication device.

8. The wireless communication device of claim 1, wherein one or more wireless communication devices are associated with BSS bandwidths including the one or more wireless channels outside of the BSS bandwidth of the wireless communication device, and wherein:
a second wireless communication device of the one or more wireless communication devices is associated with a second BSS bandwidth including a second wireless channel of the one or more wireless channels outside of the BSS bandwidth of the wireless communication device, and
a third wireless communication device of the one or more wireless communication devices is associated with a third BSS bandwidth including a third wireless channel of the one or more wireless channels outside of the BSS bandwidth of the wireless communication device.

9. The wireless communication device of claim 1, wherein, to communicate the information indicative of the at least one time period, the processing system is configured to cause the wireless communication device to:
communicate a first control frame that includes an indication of the bandwidth that includes the first wireless channel associated with the BSS bandwidth and the at least one of the one or more wireless channels outside of the BSS bandwidth, wherein communication of the first control frame is associated with a start of the time period; and
communicate a second control frame that includes an indication of the first wireless channel associated with the BSS bandwidth, wherein communication of the second control frame is associated with an end of the time period.

10. The wireless communication device of claim 9, wherein:
the first control frame is associated with a first transmission bandwidth that includes the bandwidth that includes the first wireless channel associated with the BSS bandwidth and the at least one of the one or more wireless channels outside of the BSS bandwidth, and
the second control frame is associated with a second transmission bandwidth that includes the first wireless channel associated with the BSS bandwidth.

11. The wireless communication device of claim 1, wherein the at least one time period consists of a single dynamic time period.

12. The wireless communication device of claim 1, wherein the processing system is further configured to cause the wireless communication device to:
start a random backoff counter associated with the first wireless channel at a beginning of the time period; and
sense a primary subchannel of the first wireless channel for a time duration associated with the random backoff counter, wherein communicating during the time period is in accordance with the random backoff counter reaching a zero value in association with sensing the primary subchannel.

13. The wireless communication device of claim 12, wherein the information indicative of the at least one time period further indicates that any wireless communication device capable of the communication via the expanded bandwidth is to sense a respective primary subchannel of a respective wireless channel associated with a respective BSS bandwidth of that wireless communication device to obtain channel access during the time period.

14. The wireless communication device of claim 1, wherein the processing system is further configured to cause the wireless communication device to:
switch, at a beginning of the time period, a primary subchannel of the wireless communication device from a first primary subchannel of the first wireless channel to a second primary subchannel of a second wireless channel, wherein the one or more wireless channels outside of the BSS bandwidth include the second wireless channel;
start a random backoff counter associated with the second wireless channel in association with switching the primary subchannel of the wireless communication device from the first primary subchannel to the second primary subchannel; and
sense the second primary subchannel of the second wireless channel for a time duration associated with the random backoff counter, wherein communicating during the time period is in association with sensing the second primary subchannel as idle when the random backoff counter is a zero value.

15. The wireless communication device of claim 14, wherein the information indicative of the at least one time period further indicates that any wireless communication device capable of the communication via the expanded bandwidth is to sense the second primary subchannel of the second wireless channel to obtain channel access during the time period.

16. The wireless communication device of claim 1, wherein the processing system is further configured to cause the wireless communication device to:
communicate information indicative of a capability of the wireless communication device to support communication via the expanded bandwidth that includes the first wireless channel associated with the BSS bandwidth and the one or more wireless channels outside of the BSS bandwidth, wherein communicating during the time period and via the bandwidth is in accordance with the capability of the wireless communication device.

17. A wireless communication device, comprising:
a processing system that includes processor circuitry and memory circuitry that stores code, the processing system configured to cause the wireless communication device to:
establish a wireless communication link associated with a first wireless channel, wherein the first wireless channel is associated with a basic service set (BSS) bandwidth of the wireless communication device;
sense a first primary subchannel of the first wireless channel associated with the BSS bandwidth using a first energy detection threshold value;
sense one or more primary subchannels of one or more wireless channels outside of the BSS bandwidth using a second energy detection threshold value, wherein the second energy detection threshold value is different than the first energy detection threshold value; and
communicate via a bandwidth that includes the first wireless channel associated with the BSS bandwidth and at least one of the one or more wireless channels outside of the BSS bandwidth in association with sensing the first primary subchannel associated with the BSS bandwidth using the first energy detection threshold value and sensing the one or more primary subchannels outside of the BSS bandwidth using the second energy detection threshold value.

18. The wireless communication device of claim 17, wherein the processing system is further configured to cause the wireless communication device to:
decrement a network allocation vector counter associated with the first wireless channel in association with sensing the first primary subchannel associated with the BSS bandwidth using the first energy detection threshold value and sensing the one or more primary subchannels outside of the BSS bandwidth using the second energy detection threshold value, wherein communicating via the bandwidth that includes the first wireless channel associated with the BSS bandwidth and the at least one of the one or more wireless channels outside of the BSS bandwidth is in association with sensing the first primary subchannel associated with the BSS bandwidth and at least one of the one or more primary subchannels outside of the BSS bandwidth as idle when the network allocation vector counter is a zero value.

19. The wireless communication device of claim 17, wherein, to communicate via the bandwidth that includes the first wireless channel associated with the BSS bandwidth and the at least one of the one or more wireless channels outside of the BSS bandwidth, the processing system is configured to cause the wireless communication device to:
transmit a physical layer protocol data unit (PPDU) in association with a puncturing of the PPDU, wherein the bandwidth excludes a wireless channel of the one or more wireless channels outside of the BSS bandwidth in accordance with the puncturing of the PPDU, and wherein the wireless channel is associated with an energy level value failing to satisfy the second energy detection threshold value at a transmission time.

20. The wireless communication device of claim 17, wherein, to sense the first primary subchannel associated with the BSS bandwidth and the one or more primary subchannels outside of the BSS bandwidth, the processing system is configured to cause the wireless communication device to:
sense each subchannel using a respective energy detector of the wireless communication device.

21. The wireless communication device of claim 17, wherein the processing system is further configured to cause the wireless communication device to:
maintain, in association with sensing the first primary subchannel associated with the BSS bandwidth and the one or more primary subchannels outside of the BSS bandwidth, a respective random backoff counter associated with each wireless channel of a set of wireless channels including the first wireless channel associated with the BSS bandwidth and the one or more wireless channels outside of the BSS bandwidth.

22. The wireless communication device of claim 17, wherein, to sense the first primary subchannel associated with the BSS bandwidth and the one or more primary subchannels outside of the BSS bandwidth, the processing system is configured to cause the wireless communication device to:
sense each subchannel of the first wireless channel associated with the BSS bandwidth and each subchannel of the one or more wireless channels outside of the BSS bandwidth using the first energy detection threshold value and the second energy detection threshold value, respectively, wherein communicating via the bandwidth that includes the first wireless channel and the at least one of the one or more wireless channels is in association with sensing each subchannel of the first wireless channel and each subchannel of the one or more wireless channels using the first energy detection threshold value and the second energy detection threshold value, respectively.

23. The wireless communication device of claim 17, wherein the processing system is further configured to cause the wireless communication device to:
sense the first primary subchannel of the first wireless channel associated with the BSS bandwidth using the first energy detection threshold value; and
communicate via a second bandwidth that includes at most the first wireless channel associated with the BSS bandwidth in association with sensing the first primary subchannel using the first energy detection threshold value.

24. The wireless communication device of claim 17, wherein the processing system is further configured to cause the wireless communication device to:
communicate information indicative of a capability of the wireless communication device to support communication via an expanded bandwidth that includes the first wireless channel associated with the BSS bandwidth and the one or more wireless channels outside of the BSS bandwidth, wherein sensing the first primary subchannel associated with the BSS bandwidth and the one or more primary subchannels outside of the BSS bandwidth is in accordance with the capability of the wireless communication device.

25. A method for wireless communication by a wireless communication device, comprising:
establishing a wireless communication link associated with a first wireless channel, wherein the first wireless channel is associated with a basic service set (BSS) bandwidth of the wireless communication device;
communicating information indicative of at least one time period, wherein the at least one time period is associated with communication via an expanded bandwidth that includes the first wireless channel associated with the BSS bandwidth and one or more wireless channels outside of the BSS bandwidth; and
communicating, during a time period of the at least one time period, via a bandwidth that includes the first wireless channel associated with the BSS bandwidth and at least one of the one or more wireless channels outside of the BSS bandwidth.

26. The method of claim 25, further comprising:
communicating an indication of an activation or a deactivation of a mode of operation associated with the expanded bandwidth.

27. The method of claim 25, further comprising:
communicating a frame that includes a first field and a second field, wherein the first field includes an indication of the first wireless channel associated with the BSS bandwidth and the second field includes an indication of the expanded bandwidth that includes the first wireless channel and the one or more wireless channels outside of the BSS bandwidth, wherein communicating during the time period and via the bandwidth is in accordance with the second field indicating the expanded bandwidth.

28. A method for wireless communication by a wireless communication device, comprising:
establishing a wireless communication link associated with a first wireless channel, wherein the first wireless channel is associated with a basic service set (BSS) bandwidth of the wireless communication device;
sensing a first primary subchannel of the first wireless channel associated with the BSS bandwidth using a first energy detection threshold value;
sensing one or more primary subchannels of one or more wireless channels outside of the BSS bandwidth using a second energy detection threshold value, wherein the second energy detection threshold value is different than the first energy detection threshold value; and
communicating via a bandwidth that includes the first wireless channel associated with the BSS bandwidth and at least one of the one or more wireless channels outside of the BSS bandwidth in association with sensing the first primary subchannel associated with the BSS bandwidth using the first energy detection threshold value and sensing the one or more primary subchannels outside of the BSS bandwidth using the second energy detection threshold value.

29. The method of claim 28, further comprising:
communicating information indicative of a capability of the wireless communication device to support communication via an expanded bandwidth that includes the first wireless channel associated with the BSS bandwidth and the one or more wireless channels outside of the BSS bandwidth, wherein sensing the first primary subchannel associated with the BSS bandwidth and the one or more primary subchannels outside of the BSS bandwidth is in accordance with the capability of the wireless communication device.

30. The method of claim 29, wherein:
the information indicative of the capability further indicates that the wireless communication device lacks parallel energy detectors, and
transmission via the expanded bandwidth from the wireless communication device is restricted to trigger-based transmissions in association with the wireless communication device lacking the parallel energy detectors.
